(19) United States
(12) Patent Application Publication
(10) Pub. No.: US 2016/0179899 A1
(43) Pub. Date: Jun. 23, 2016

(54) METHOD OF PROVIDING CONTENT AND ELECTRONIC APPARATUS PERFORMING THE METHOD

(71) Applicant: SAMSUNG ELECTRONICS, CO., LTD., Suwon-si (KR)

(72) Inventor: Su-min LIM, Yongin-si (KR)

(21) Appl. No.: 14/976,919

(22) Filed: Dec. 21, 2015

(30) Foreign Application Priority Data
Dec. 19, 2014 (KR) 10-2014-0184715

(51) Int. Cl. G06F 17/30

(52) U.S. Cl. CPC G06F 17/30525; G06F 17/30867; G06F 17/30528; G06F 17/3053

(57) ABSTRACT

A content providing method and an electronic apparatus performing the content providing method are provided. The content providing method includes acquiring at least one content item from a content provider, extracting at least one tagged value from each of the at least one user content item, producing a tag list, based on the extracted at least one tagged value, and searching for content of interest by using the at least one tagged value included in the tag list.

### CROSS-REFERENCE TO RELATED PATENT APPLICATION

This application is based on and claims priority under 35 U.S.C. §119 to Korean Patent Application No. 10-2014-0184715, filed on Dec. 19, 2014, in the Korean Intellectual Property Office, the disclosure of which is incorporated by reference herein in its entirety.

### BACKGROUND

1. Field

The disclosure relates to a method of providing content, and an electronic apparatus performing the method.

2. Description of Related Art

Due to developments in network and multimedia technologies, users may generate content via a service over a network, and the users or other people may use the user generated content. However, types and amount of contents provided through various services are massive, and thus, users are indiscriminately exposed to unnecessary content. In addition, users have difficulty in effectively searching for and managing contents that are generated via various services and used. Thus, there is a demand for a technique of allowing users to effectively manage content and of effectively providing content that the users are interested in.

### SUMMARY

According to an example of the disclosure, a content providing method includes acquiring at least one content item from a content provider; extracting at least one tagged value from each of the at least one content item; generating a tag list, based on the extracted at least one tagged value; and searching for content of interest using the at least one tagged value included in the tag list.

The extracted at least one tagged value may be listed within the tag list, and the tag list may be generated by indexing the content including the extracted tagged value with the extracted tagged value.

The at least one content may be acquired based on respective weights of content usage behaviors.

The content providing method may further include classifying the at least one content, based on the content usage behaviors of the user; and displaying the classified at least one content.

The content providing method may further include tagging the content with another or a new tagged value; updating the tag list, based on the tagged content; and transmitting information about the tagging to the content provider.

The tagging of the content may include recommending a plurality of candidate tagged values, based on at least one of the at least one tagged value included in the tag list and keywords included in the content; and in response to selecting at least one from the plurality of candidate tagged values, tagging the content with the selected candidate tagged value.

The content providing method may further include tagging the content with a keyword the same as the at least one tagged value included in the tag list from among keywords included in the content; updating the tag list, as the content is tagged with the keyword; and transmitting information about the tagging to the content provider.

The tag list may be produced in a hierarchical structure including an upper tagged value and a lower tagged value.

The content of interest may be found from the at least one content.

The content of interest may be found from content items included in a subscribed to really simple syndication (RSS) feed.

The content of interest may be found from content items of other users who are friends of the user, and the searching for the content of interest may include acquiring the content items of the other users including a tag value that is the same as the at least one tagged value included in the tag list.

According to an example of the disclosure, an electronic apparatus includes communication circuitry configured to acquire at least one content item from a content provider; a processor configured to extract at least one tagged value from each of the at least one content item, to produce a tag list based on the extracted at least one tagged value, and to search for content of interest using the at least one tagged value included in the tag list; and a display configured to display the content of interest.

The processor may be configured to index the content including the extracted at least one tagged value with the extracted at least one tagged value, and the tag list may be generated by indexing the content including the extracted at least one tagged value with the extracted at least one tagged value.

The at least one content may be acquired based on respective weights of content usage behaviors.

The processor may be configured to classify the at least one content, based on the content usage behaviors of the user, and the display may be configured to display the classified at least one content.

The processor may be configured to tag the content with another or new tagged value, and to update the tag list based on the tagged content, and the communication circuitry may be configured to transmit information about the tagging to the content provider.

The processor may be configured to recommend a plurality of candidate tagged values, based on at least one of the at least one tagged value included in the tag list and keywords included in the content, and, in response to selecting at least one from the plurality of candidate tagged values, may tag the content with the selected candidate tagged value.

The processor may be configured to tag the content with a keyword that is the same as the at least one tagged value included in the tag list from among keywords included in the content, and to update the tag list as the content is tagged with the keyword, and the communication circuitry may be configured to transmit information about the tagging to the content provider.

The content of interest may be found from the at least one content.

The content of interest may be found from content items included in a subscribed to really simple syndication (RSS) feed.

The content of interest may be found from content items of other users who are friends of the user, and the communication circuitry may be configured to acquire the content items of the other users including a tag value that is the same as the at least one tagged value included in the tag list.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1 is a block diagram illustrating an example content providing system;

FIG. 2 is a flowchart illustrating an example method in which an electronic apparatus produces a tag list using content and searches for content of interest using tag values included in the tag list;

FIG. 3A is a diagram illustrating an example of content including a hash-tag;

FIG. 3B is a diagram illustrating an example of a content management table that is produced by the electronic apparatus as the user content is acquired;

FIG. 4 is a diagram illustrating an example in which the electronic apparatus produces a tag list based on a content management table;

FIG. 5 is a flowchart illustrating an example method in which the electronic apparatus produces a tag list based on preferred content in which a preference has been reflected;

FIG. 6 is a diagram illustrating an example of weights for content usage behaviors of a user;

FIG. 7 is a flowchart illustrating an example method in which the electronic apparatus acquires content from a content provider;

FIG. 8 is a diagram illustrating an example in which the electronic apparatus displays a content provider list and an authentication user interface (UI) for user authentication;

FIG. 9 is a flowchart illustrating an example method in which the electronic apparatus displays content items according to content usage behaviors of the user;

FIG. 10 is a diagram illustrating an example of a screen of the electronic apparatus on which content items are displayed according to content usage behaviors of the user;

FIG. 11 is a flowchart illustrating an example method in which the electronic apparatus tags a new tag value to content;

FIG. 12 is a diagram illustrating an example in which the electronic apparatus tags a text included in the content of FIG. 3A to the content;

FIG. 13 is a diagram illustrating an example in which the electronic apparatus tags a new tag value to the content of FIG. 3A;

FIG. 14 is a diagram illustrating an example in which the electronic apparatus updates a content management table;

FIG. 15 is a diagram illustrating an example in which the electronic apparatus updates a tag list based on an updated content management table;

FIG. 16 is a flowchart illustrating an example method in which the electronic apparatus recommends a tagged value for tagging content;

FIG. 17 is a diagram illustrating an example in which the electronic apparatus recommends a candidate tagged value and tags the recommended candidate tagged value to content;

FIG. 18 is a diagram illustrating an example in which a tag list is updated as the electronic apparatus tags content with a recommended candidate tagged value;

FIG. 19 is a flowchart illustrating an example method in which the electronic apparatus automatically tags content;

FIG. 20 is a diagram illustrating an example in which the electronic apparatus automatically tags content;

FIG. 21 is a flowchart illustrating an example method in which the electronic apparatus searches for content of interest;

FIG. 22 is a diagram illustrating an example in which the electronic apparatus displays content of interest using a tag list;

FIG. 23 is a diagram illustrating an example in which the electronic apparatus automatically tags content;

FIG. 24 is a diagram illustrating an example in which the electronic apparatus searches for content of interest using a tag list including an upper tagged value and a lower tagged value;

FIG. 25 is a block diagram illustrating an example content providing system including a cloud server;

FIG. 26 is a flowchart illustrating an example method in which the electronic apparatus receives content and content of interest from the cloud server;

FIG. 27 is a diagram illustrating an example of a second content management table that is produced by the cloud server;

FIG. 28 is a flowchart illustrating an example method in which the electronic apparatus searches for content items of other users who are friends of a user of the electronic apparatus;

FIG. 29 is a flowchart illustrating an example method in which the electronic apparatus receives content and content of interest from the cloud server;

FIG. 30 is a diagram illustrating an example of a second content management table that is produced by the cloud server;

FIG. 31 is a flowchart illustrating an example method in which the electronic apparatus searches for content items of other users who are friends of a user of the electronic apparatus;

FIG. 32 is a diagram illustrating an example in which the electronic apparatus provides content of interest to the electronic apparatus;

FIG. 33 is a diagram illustrating an example in which the electronic apparatus provides content of interest to the electronic apparatus;

FIG. 34 is a flowchart illustrating an example method in which the electronic apparatus displays a tag list of other users who are friends of a user of the electronic apparatus;

FIG. 35 is a diagram illustrating an example in which the electronic apparatus displays a tag list of other users who are friends of a user of the electronic apparatus;

FIG. 36 is a flowchart illustrating an example method in which the electronic apparatus tags content displayed on another application execution window;

FIG. 37 is a diagram illustrating an example in which the electronic apparatus tags content displayed on the screen while executing another application;

FIG. 38 is a flowchart illustrating an example method in which the electronic apparatus tags a search formula input via a search UI to found content;

FIG. 39 is a diagram illustrating an example in which the electronic apparatus tags a search formula input via a search UI to found content;

FIG. 40 is a flowchart illustrating an example method in which the electronic apparatus acquires content from a content provider at regular intervals;

FIG. 41 is a diagram illustrating an example in which the electronic apparatus diversifies the backup time interval based on states of the electronic apparatus; and

FIGS. 42 and 43 are block diagrams illustrating an example electronic apparatus.

### DETAILED DESCRIPTION

The terms used in the disclosure will be briefly described, and then examples will be described in greater detail.

Although general terms widely used at present were selected for describing the examples in consideration of the functions thereof, these general terms may vary according to intentions of one of ordinary skill in the art, case precedents, the advent of new technologies, and the like. Terms arbitrarily selected by the applicant may also be used in an example case. Hence, the terms should be defined based on their meanings and the content of the entire disclosure, not by simply stating the terms.

The terms “comprises” and/or “comprising” or “includes” and/or “including” when used in this disclosure, specify the presence of stated elements, but do not preclude the presence or addition of one or more other elements. The terms “ . . . unit” and “ . . . module” when used in this disclosure may refer to a unit in which at least one function or operation is performed, and may be implemented as hardware (e.g., circuitry), software, or a combination of hardware and software.

In the disclosure, content may, for example, denote or refer to digital information provided through the Internet, a computer communication, or the like. Examples of content may include, but are not limited to, video content, such as a TV program, a video on demand (VOD), a personal video (for example, user-created content (UCC)), a music video, and a YouTube video, still image content, such as a picture and a drawing, text content, such as an electronic book (a poem or a novel), a letter, and a business file, music content, such as music, a musical program, and a radio broadcast, a web page, and application execution information, or the like.

In the disclosure, tagging may denote or refer to assigning content with a tagged value that may be representative of the content. Examples of the tagged value may include, but are not limited to, a word representing a theme, category, and keyword of the content and an emotion, situation, and will of a content user, and a text or image included in the content.

In the disclosure, indexing may denote or refer to an operation, performed by an electronic apparatus, of mapping content with a predetermined search key in order to search for the content. For example, when the electronic apparatus indexes content with a tagged value included in the content, the electronic apparatus may search for the content mapped with the tagged value by using the tagged value as a search key.

In the disclosure, an input may, for example, be a touch input, a voice input, a button input, or a gesture input of moving the electronic apparatus. The touch input may be made by at least one gesture from among touching, holding, tapping, dragging, flicking, pinching, touching & dragging, and toughing & holding.

Examples of the disclosure are described in greater detail herein with reference to the accompanying drawings so that this disclosure may be easily understood by one of ordinary skill in the art to which the disclosure pertains. The disclosure may, however, be embodied in many different forms and should not be construed as being limited to the examples set forth herein. In the drawings, parts irrelevant to the description may be omitted for simplicity of explanation, and like numbers refer to like elements throughout.

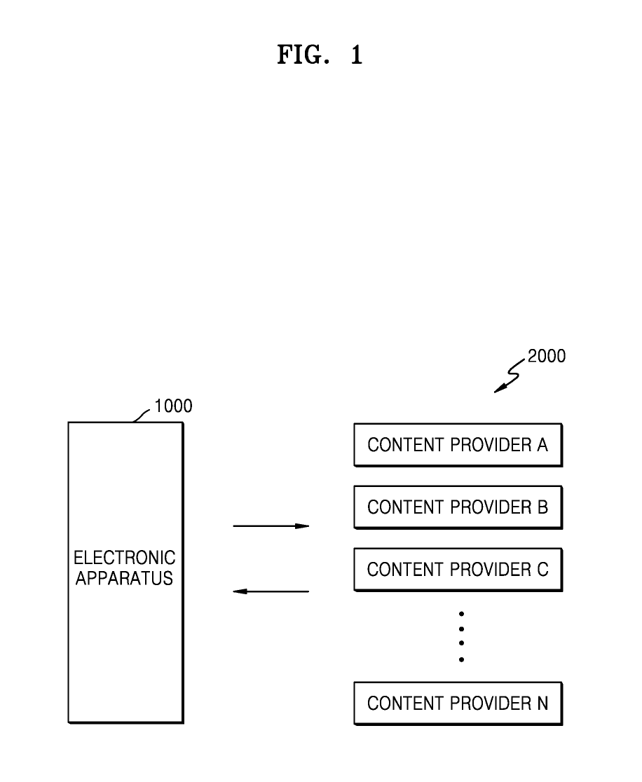

FIG. 1 is a block diagram illustrating an example content providing system.

Referring to FIG. 1, the content providing system may include, for example, an electronic apparatus 1000 and at least one content provider 2000.

The electronic apparatus 1000 may acquire at least one content of a user from the different content providers 2000. Content of a user may, for example, refer to content related with the user. For example, the content or user content may include at least one of content produced by the user, content used by the user, and content owned by the user. The content produced by the user may be, for example, a text written by the user, an image captured by the user, or a moving picture captured by the user. The content used by the user may be, for example, content uploaded by the user, content reproduced by the user, content downloaded by the user, content tagged by the user, or content commented on by the user. The user content may be provided via servers that are operated by the content providers 2000. The user content may be referred to in the disclosure simply as content.

The electronic apparatus 1000 may, for example, store the user content in at least one of the electronic apparatus 1000 and a cloud server. The electronic apparatus 1000 may extract tagged values from each user content item and generate a user tag list by using the extracted tagged values. The user tag list may be a list of tagged values included in each of user content items that are provided by the different content providers 2000. The user tag list may be produced by indexing the user content including the extracted tagged values with the extracted tagged values. The electronic apparatus 1000 may tag a new tagged value to the user content. For example, the user tag list may be updated to include the new tagged value, and information about the tagging may be transmitted to a content provider 2000 corresponding to the user tag list. The electronic apparatus 1000 may easily access and manage the user content items that are provided from the different content providers 2000, using the user tag list.

The electronic apparatus 1000 may search for content of interest of the user by using the tagged values included in the user tag list. The content of interest may be content found using the tagged values included in the user tag list from among content items that are provided by a content provider 2000 to which the user of the electronic apparatus 1000 has subscribed or a content provider 2000 to which the user of the electronic apparatus 1000 has not subscribed. For example, the content of interest may be content found from content items included, for example, in a really simple syndication (RSS) feed that is provided by an RSS provider to which the user has subscribed. However, the examples are not limited thereto, and the content of interest may be content that is produced directly by the user.

Examples of the electronic apparatus 1000 may include, but are not limited to, a smartphone, a tablet personal computer (PC), a PC, a smart TV, a mobile phone, a PDA, a laptop, a media player, a micro-server, a global positioning system (GPS) device, an electronic book terminal, a digital broadcasting terminal, a navigation device, a kiosk, an MP3 player, a digital camera, and other mobile or non-mobile computing devices, or the like. The electronic apparatus 2000 may be any of various apparatuses capable of receiving a touch input, such as, an electronic frame or an electronic blackboard, and displaying an image, or the like. The electronic apparatus 1000 may be a watch and eyeglasses including a communication function and a data processing function, or the like. However, examples are not limited thereto, and the electronic apparatus 1000 may be any kind of apparatus capable of acquiring content that is provided by the content provider 2000 via, for example, a network.

The content provider 2000 may provide content to the electronic apparatus 1000 and provide a service enabling a user to use content via the electronic apparatus 1000. The content providers 2000 may include, for example, a social media content provider, an RSS provider, a news content provider, a moving picture content provider, and a broadcasting content provider, but are not limited thereto.

Examples of the network may include a Local Area Network (LAN), a Wide Area Network (WAN), a Value Added Network (VAN), a mobile radio communication network, a satellite communication network, and a combination thereof. The network may, for example, refer to a data communication network of a comprehensive meaning that enables network configuring subjects illustrated in FIG. 1 to smoothly communicate with one another. Examples of the data communication network may include the wired Internet, the wireless Internet, and a mobile wireless communication network, etc.

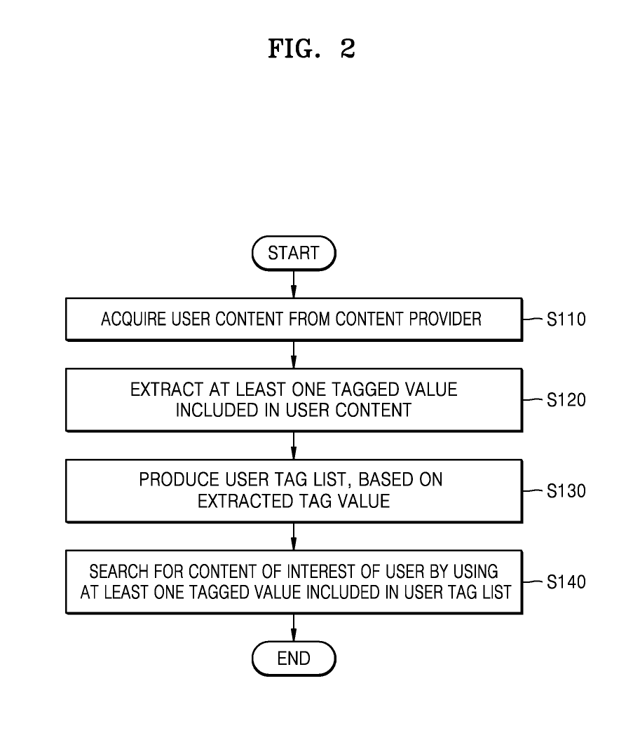

FIG. 2 is a flowchart illustrating an example method in which the electronic apparatus 1000 produces a user tag list by using content of a user and searches for content of interest by using tag values included in the user tag list.

Referring to FIG. 2, in operation S110, the electronic apparatus 1000 may acquire the user content from a content provider 2000. The user content may, for example, refer to content related with the user. For example, the user content may include at least one of content produced by the user, content used by the user, and content owned by the user. The electronic apparatus 1000 may acquire the user content from a preset content provider 2000 or acquire the user content from a content provider 2000 selected based on a user input. For example, the electronic apparatus 1000 may provide a user interface (UI) for selecting a content provider 2000.

In operation S120, the electronic apparatus 1000 may extract a tagged value included in the user content. For example, when the user content includes a hash-tag, the electronic apparatus 1000 may extract a text corresponding to the hash-tag, as the tagged value. The hash-tag may, for example, refer to a tag that is produced to search for content. For example, the hash-tag may be expressed as ‘#text’. The electronic apparatus 1000 may extract the tagged value included in the user content via an Application Programming Interface (API) that is provided by the content provider 2000. The electronic apparatus 1000 may extract, as the tagged value, a text or image displayed together with a specific mark (for example, a parenthesis, ‘!’, or ‘@’) from the user content.

The electronic apparatus 1000 may tag a new tagged value to the user content. For example, the electronic apparatus 1000 may tag a tagged value produced based on a user input to the user content. The electronic apparatus 1000 may automatically generate a tagged value and may tag the generated tagged value to the user content. The tagged value that is automatically produced may be, for example, a keyword that is the same as a tagged value included in a tag list of the user from among keywords included in the user content.

The electronic apparatus 1000 may store a time point of the tagging together with the new tagged value, based on the type of user content. For example, when the electronic apparatus 1000 tags the new tagged value to video content, the electronic apparatus 1000 may store a reproducing time period of the video content at the tagging time point. When the electronic apparatus 1000 tags the new tagged value to audio content, the electronic apparatus 1000 may store a reproducing time period (e.g., 0:50) of the audio content at the tagging time point.

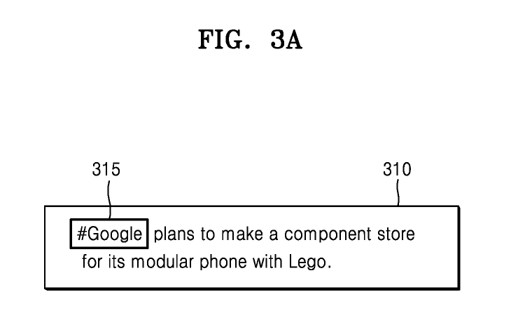

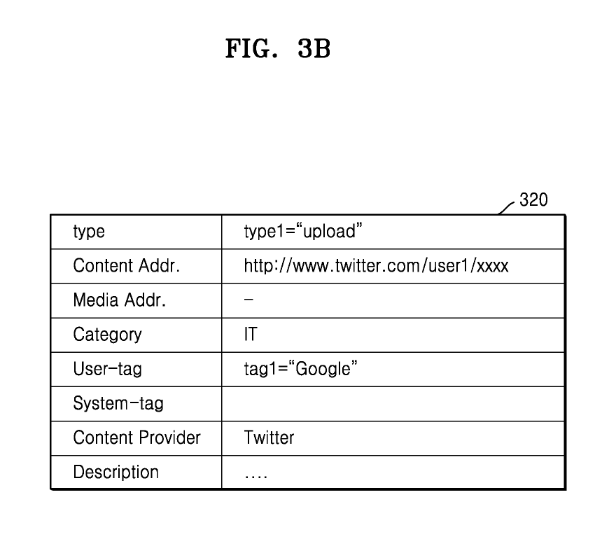

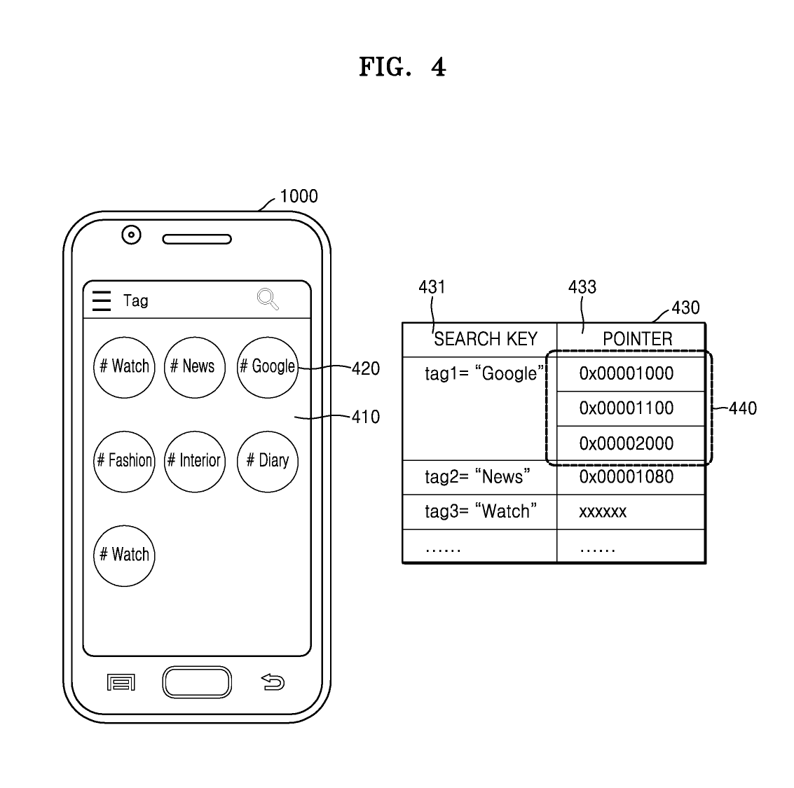

In operation S130, the electronic apparatus 1000 may produce a user tag list, based on the extracted tag value. The user tag list may be produced by indexing information about each of the user content items provided by the different content providers 2000 with the tagged value included in the user content. For example, the electronic apparatus 1000 may produce a content management table for each user content item. The content management table may, for example, include at least one of meta information of the user content, the tagged value included in the user content, and information about the content provider 2000. The electronic apparatus 1000 may index the content management table with the tagged value. The electronic apparatus 1000 may provide the user with a user tag list including tagged values mapped with the indexed content management table. Accordingly, the electronic apparatus 1000 may rapidly access the content management table including the same tagged values as those included in the user tag list. A method in which the electronic apparatus 1000 produces a content management table, and a method in which the electronic apparatus 1000 indexes the content management table with a tagged value will be described below with reference to FIGS. 3A-4.

When the electronic apparatus 1000 tags the new tagged value to the user content, the electronic apparatus 1000 may update the user tag list. The electronic apparatus 1000 may transmit tagging information to the content provider 2000 to enable the content provider 2000 to add the tagged value to the user content.

The electronic apparatus 1000 may provide an adding UI for adding the new tagged value to the user tag list. For example, the electronic apparatus 1000 may search for user content including the new tagged value, and tag the new tagged value to found content. For example, when a user wants to use user content including a specific word, the user may add the specific word as a new tagged value to the user tag list, via the adding UI. For example, the electronic apparatus 1000 may search for user content including the new tagged value, and tag the new tagged value to found user content. Accordingly, the user may use the user content including the specific word via the user tag list at a desired time point. As such, the electronic apparatus 1000 may easily use the user content via the user tag list.

In operation S140, the electronic apparatus 1000 may search for content of interest of the user by using at least one tagged value included in the user tag list. The content of interest may be content found using the tagged values included in the user tag list from among content items that are provided by a content provider 2000 to which the user of the electronic apparatus 1000 has subscribed or a content provider 2000 to which the user of the electronic apparatus 1000 has not subscribed. According to some examples, the content of interest may be content found from the user content. The content of interest may be content found from content items included in an RSS feed to which the user subscribes. The content of interest may be content found from content items that are provided by a news content provider. The content of interest may be content found from content items of other users who are friends of the user of the electronic apparatus 1000. For example, the electronic apparatus 1000 may acquire information about the other users and content of the other users from the cloud server.

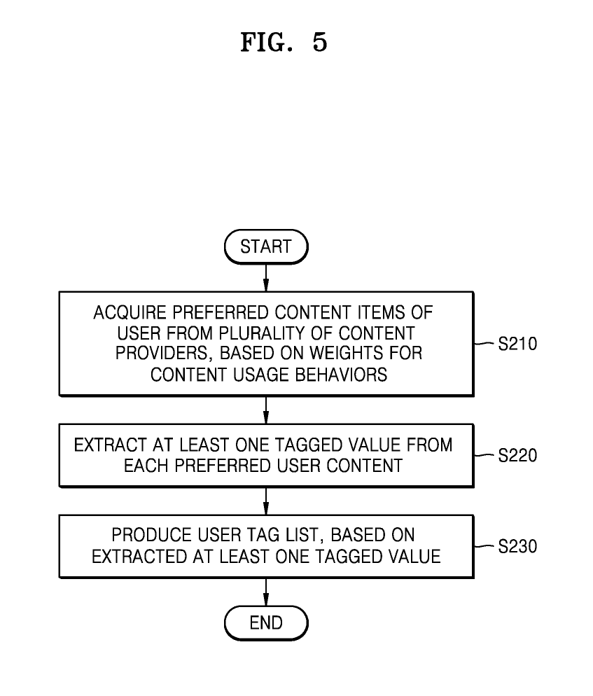

According to some examples, the electronic apparatus 1000 may select and acquire highly-preferred user content from the content provider 2000 in order to provide a significant user tag list to the user. For example, the electronic apparatus 1000 may acquire content in which preference of the user has been reflected (hereinafter, referred to as preferred content), from the content provider 2000 based on respective weights for content usage behaviors of the user. A method in which the electronic apparatus 1000 acquires preferred content will be described below with reference to FIG. 5.

FIG. 3A illustrates an example of content of a user including a hash-tag “#Google”. FIG. 3B illustrates an example of a content management table that is produced by the electronic apparatus 1000 as the user content is acquired.

According to some examples, when user content is newly acquired, the electronic apparatus 1000 may produce a content management table 320. The content management table 320 may include, for example, at least one of meta information of the user content, the tagged value included in the user content, and information about a content provider. For example, the content management table 320 may include at least one field from among a content type, a content address, a media address, a category, a user tag, a system tag, a content provider, and a description field. The content type may be information about a usage behavior of the user with respect to the user content. For example, the content type may be ‘link’, ‘upload’, or ‘scrap’. The content address may include at least one of the address of a server that is operated by the content provider 2000 having content stored therein, the address of a cloud server having content stored therein, and a memory address of the electronic apparatus 1000 having content stored therein. The user tag may include a tagged value generated by the user from among the tagged values included in the content. The system tag may include a tagged value automatically generated by the electronic apparatus 1000 from among the tagged values included in the content. The content provider may include information about a content provider 2000 that has provided the content. When the content is audio or video content, the description field may include, for example, an audio or video reproducing time period at a time point when the content is tagged.

For example, as illustrated in FIG. 3A, when content 310 of the user provided by a first content provider (for example, Twitter) includes a hash-tag “#Google” 315, the electronic apparatus 1000 may extract a tagged value “Google” from the content 310 of the user. Accordingly, the electronic apparatus 1000 may produce a content management table in which a content provider field is “Twitter” and a user tag field is tag1=‘Google’. When the content 310 of the user is content uploaded by the user to the first content provider, the content type field of the content management table may be ‘type1=“upload’”.

The content management table 320 may be indexed using a value included in each field. For example, the electronic apparatus 1000 may index the content management table by using a tagged value included in the user tag field. Accordingly, the electronic apparatus 1000 may easily access a desired content management table by using a tag value.

The electronic apparatus 1000 may, for example, store the content management table 320 and the user content in at least one of the electronic apparatus 1000 and a cloud server.

FIG. 4 illustrates an example in which the electronic apparatus 1000 produces a user tag list based on a content management table.

According to some examples, the electronic apparatus 1000 may store a content management table for each content item. The electronic apparatus 1000 may produce an index table 430 by indexing the stored content management table with the tagged value included in the user tag field of the stored content management table. As illustrated on the right side of FIG. 4, the index table 430 may include a search key field 431 including tagged values, and a pointer field 433 having an address where a content management table indexed with each tag value is stored (for example, a memory address ‘0x0001000’ of the electronic apparatus 1000 when the content management table indexed with each tag value is stored in the electronic apparatus 1000).

The electronic apparatus 1000 may generate a user tag list 410 including the tagged values included in the search key field 431 of the index table 430. For example, the electronic apparatus 1000 may display a user tag list 410 including images or texts respectively corresponding to the tagged values included in the search key field 431. According to some examples, the user tag list 410 may include images marked with the tagged values, as illustrated on the left side of FIG. 4.

When the electronic apparatus 1000 receives a user input regarding an image corresponding to a specific tagged value, the electronic apparatus 1000 may provide user content including the specific tag value. For example, the electronic apparatus 1000 may receive a user input regarding an image 420 marked with “#Google” corresponding to a tagged value “Google”. For example, the electronic apparatus 1000 may acquire an address 440 where a content management table corresponding to the user-input tagged value “Google” is stored, via the search key field 431 corresponding to the tagged value “Google” of the index table 430. The electronic apparatus 1000 may acquire user content including the tagged value “Google”, via the content address field of each content management table.

When the electronic apparatus 1000 receives a user input regarding an image corresponding to a specific tagged value, the electronic apparatus 1000 may provide content items of other users including the specific tag value. For example, in response to a user input regarding the image marked with the tagged value “Google”, the electronic apparatus 1000 may provide content including the tagged value “Google” from among content items included in an RSS feed to which the user subscribes.

Although it has been described above that the electronic apparatus 1000 produces an index table having the tagged value field of a content management table as a search key field, examples are not limited thereto. For example, the electronic apparatus 1000 may produce a content type index table having the content type field of a content management table as a search key field. For example, the electronic apparatus 1000 may easily search for and acquire user content corresponding to each content type, using the content type index table. The electronic apparatus 1000 may produce a content provider index table having the content provider field of a content management table as a search key field. As such, the electronic apparatus 1000 may rapidly provide content desired by a user, by generating and storing a plurality of index tables.

FIG. 5 is a flowchart illustrating an example method in which the electronic apparatus 1000 produces a user tag list based on preferred content in which preference of a user has been reflected.

Referring to FIG. 5, in operation S210, the electronic apparatus 1000 may acquire preferred user content items from a plurality of content providers 2000, based on weights for content usage behaviors of the user.

The content usage behaviors of the user may include, but are not limited to, a tag input for content, content bookmarking, content upload, content download, content scrap, a preference input for content, content reproduction, and a comment input for content. The content usage behaviors of the user may include various other behaviors of the user using content. The preference input for content may denote inputting an emotion (for example, being joyful, sad, or nice), preference (for example, like or dislike), or the like of the user with respect to the content.

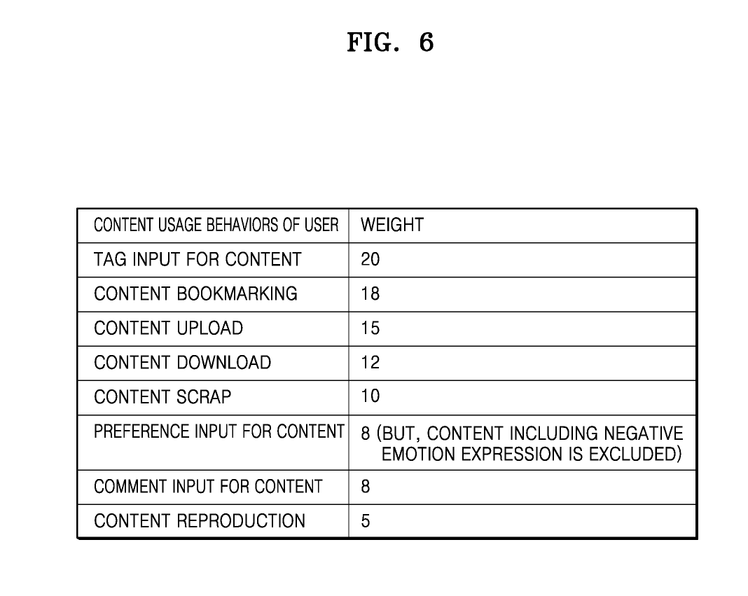

FIG. 6 illustrates an example of the weights for content usage behaviors of the user.

Referring to FIG. 6, the electronic apparatus 1000 may set weights corresponding to content usage behaviors of each user. For example, when a user inputs a tag to content, the electronic apparatus 1000 may set a weight ‘20’, and, when the user reproduces the content, the electronic apparatus 1000 may set a weight ‘5’. The electronic apparatus 1000 may determine whether to acquire each content, based on a sum of weights for each content. For example, the electronic apparatus 1000 may determine whether to acquire content, based on whether a sum of the weights for the content exceeds ‘10’. If the user scraps (weight ‘10’) first content, the electronic apparatus 1000 may not acquire the first content. However, when the user inputs a preference (for example, ‘like’) (weight ‘8’) for the first content while scrapping (weight ‘10’) the first content, the electronic apparatus 1000 may acquire the first content.

The weights for the content usage behaviors of the user may be changed based on a user input made to the electronic apparatus 1000 or settings of the electronic apparatus 1000. For example, the electronic apparatus 1000 may change a weight for a behavior of inputting a comment on content from ‘8’ to ‘15’, in response a user input. The electronic apparatus 1000 may set a high weight to a most-frequent content usage behavior by analyzing the weights for the content usage behaviors of the user.

Referring back to FIG. 5, in operation S220, the electronic apparatus 1000 may extract at least one tagged value from each preferred user content. In operation S230, the electronic apparatus 1000 may produce a user tag list, based on the extracted at least one tagged value. Accordingly, the user tag list may be comprised of the at least one tagged value extracted from the preferred content in which preference of the user has been reflected.

As such, the electronic apparatus 1000 according to some examples may acquire the preferred user content in order to provide a significant user tag list to the user. When the electronic apparatus 1000 needs to receive an excessively large amount of content from the content providers 2000 or a processing load of the electronic apparatus 1000 is high, the electronic apparatus 1000 may preferentially acquire the preferred content. Accordingly, the electronic apparatus 1000 may provide the user with a user tag list in which preference of the user has been reflected, without processing an excessively large amount of data.

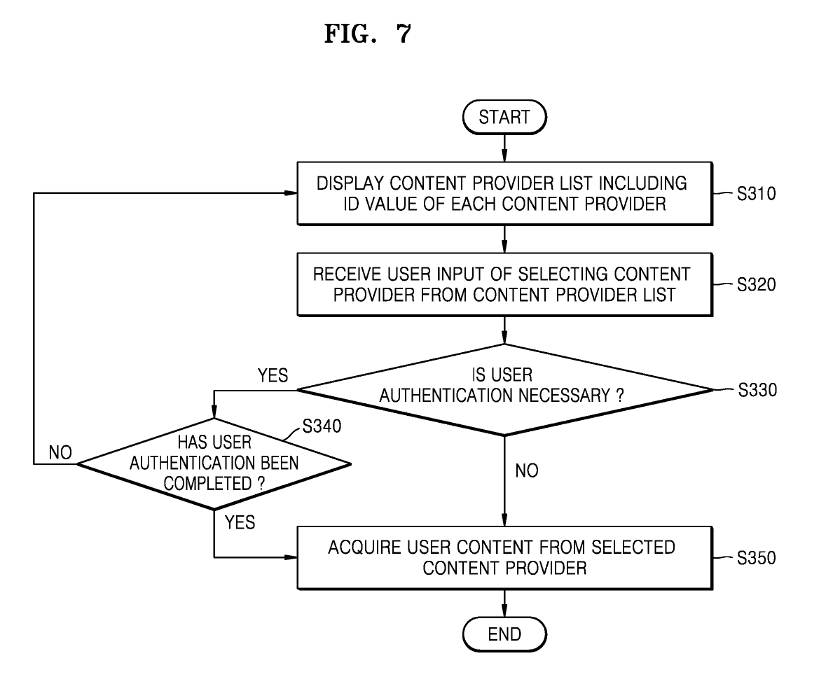

FIG. 7 is a flowchart illustrating an example method in which the electronic apparatus 1000 acquires content of a user from a content provider.

According to some examples, the electronic apparatus 1000 may provide a UI for receiving a user input of selecting a content provider 2000. In operation S310, the electronic apparatus 1000 may display a content provider list including an ID value of each content provider 2000. In operation S320, the electronic apparatus 1000 may receive a user input of selecting a content provider from the content provider list. In operation S330, the electronic apparatus 1000 may determine whether user authentication is necessary for accessing the selected content provider.

When user authentication is not necessary, the electronic apparatus 1000 may acquire the user content from the selected content provider, in operation S350. When user authentication is necessary, the electronic apparatus 1000 may provide an authentication UI for authenticating the user. For example, the electronic apparatus 1000 may display an authentication UI on a screen of the electronic apparatus 1000 that is provided with the content provider list. When user authentication has been completed via the authentication UI in operation S340, the electronic apparatus 1000 may acquire the user content from the selected content provider, in operation S350. When the user authentication is refused, the electronic apparatus 1000 may display the content provider list again, in operation S310.

Although it has been described above that the electronic apparatus 1000 receives a user input of selecting one content provider, examples are not limited thereto. For example, the electronic apparatus 1000 may receive a user input of selecting a plurality of content providers. For example, the electronic apparatus 1000 may determine whether user authentication is necessary for accessing each of the plurality of content providers. When user authentication is necessary, the electronic apparatus 1000 may provide an authentication UI for user authentication for each content provider. The electronic apparatus 1000 may acquire the user content from an authorized content provider.

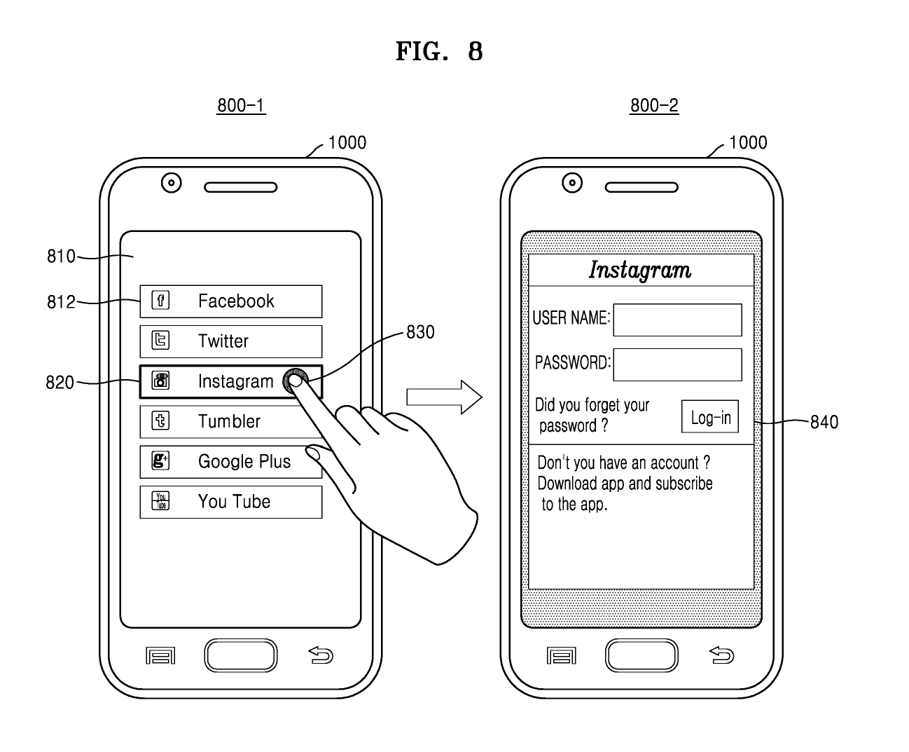

FIG. 8 illustrates an example in which the electronic apparatus 1000 displays a content provider list and an authentication UI for user authentication.

Referring to FIG. 8, the electronic apparatus 1000 may display a content provider list 810 including ID values of content providers 2000. For example, the electronic apparatus 1000 may display a content provider list 810 including icons and names 812 of content providers (800-1). The electronic apparatus 1000 may receive a user input 830 of selecting a field 820 corresponding to a first content provider (for example, Instagram) from the content provider list 810. If user authentication for accessing the first content provider is not necessary or the user authentication has already been completed, the electronic apparatus 1000 may acquire the user content from the first content provider.

If user authentication for accessing the first content provider is necessary, the electronic apparatus 1000 may display an authentication UI 840 for the user authentication (800-2). When the user authentication is completed, the electronic apparatus 1000 may acquire the user content from the first content provider. When the user authentication is refused, the electronic apparatus 1000 may display the content provider list 810 again (800-1).

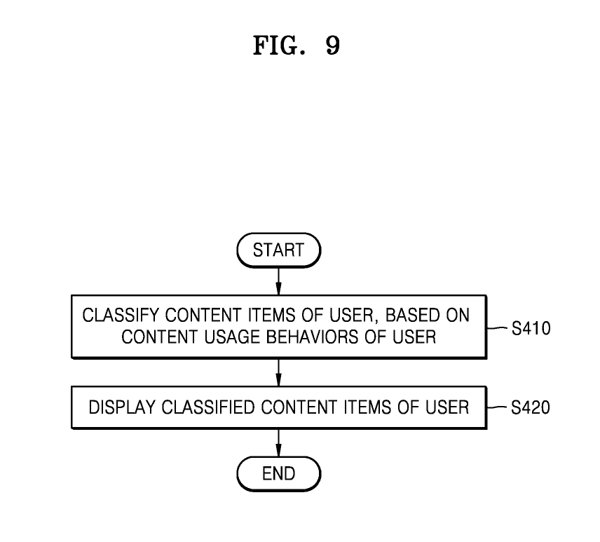

FIG. 9 is a flowchart illustrating an example method in which the electronic apparatus 1000 displays user content items according to content usage behaviors of the user.

Referring to FIG. 9, in operation S410, the electronic apparatus 1000 may classify the user content items, based on the content usage behaviors of the user. For example, the electronic apparatus 1000 may classify the user content items into content scrapped by the user, content uploaded by the user, and content to which a comment has been input by the user, etc. The electronic apparatus 1000 may classify the user content items according to the content usage behaviors of the user, using, for example, a content management table. For example, the electronic apparatus 1000 may index the content management table using a content type field of the content management table. The electronic apparatus 1000 may easily acquire user content including a specific content type, via the content management table indexed with a content type.

In operation S420, the electronic apparatus 1000 may display the classified user content items. The electronic apparatus 1000 may display images corresponding to tagged values included in the classified user content items, together with the classified user content. For example, the electronic apparatus 1000 may extract tagged values included in each user content items from content management tables of the content items and display images corresponding to the tagged values.

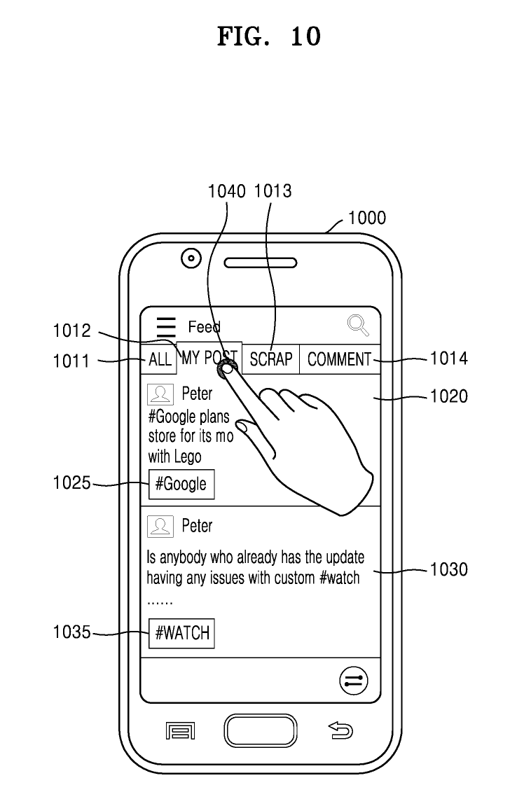

FIG. 10 illustrates an example of a screen of the electronic apparatus 1000 on which user content items are displayed according to content usage behaviors of the user.

Referring to FIG. 10, the electronic apparatus 1000 may classify the user content items into content written by the user, content scrapped by the user, and content to which a comment has been input by the user, according to the content usage behaviors of the user. For example, the electronic apparatus 1000 may display a “MY POST” field 1012 for providing content written by the user, a “SCRAP” field 1013 for providing content scrapped by the user, a “COMMENT” field 1014 for providing content to which a comment has been input by the user, and an “ALL” field 1011 for sequentially providing content items of all users.

When the electronic apparatus 1000 receives a user input 1040 of selecting the “MY POST” field 1012, the electronic apparatus 1000 may display first content 1020 and second content 1030 written by the user. The first content 1020 and the second content 1030 may be user content items which are acquired from different content providers 2000. The electronic apparatus 1000 may extract a first tagged value “Google” included in the first content 1020 and a second tagged value “Watch” included in the second content 1030, from content management tables respectively corresponding to the first content 1020 and the second content 1030. The electronic apparatus 1000 may display a “#Google” image 1025 marked with the extracted first tagged value “Google” and a “#Watch” image 1035 marked with the extracted second tagged value “Watch”, together with the first content 1020 and the second content 1030. If the electronic apparatus 1000 receives a user input of selecting the “#Google” image 1025, the electronic apparatus 1000 may provide user content including the tagged value “Google” for each content usage behavior of the user.

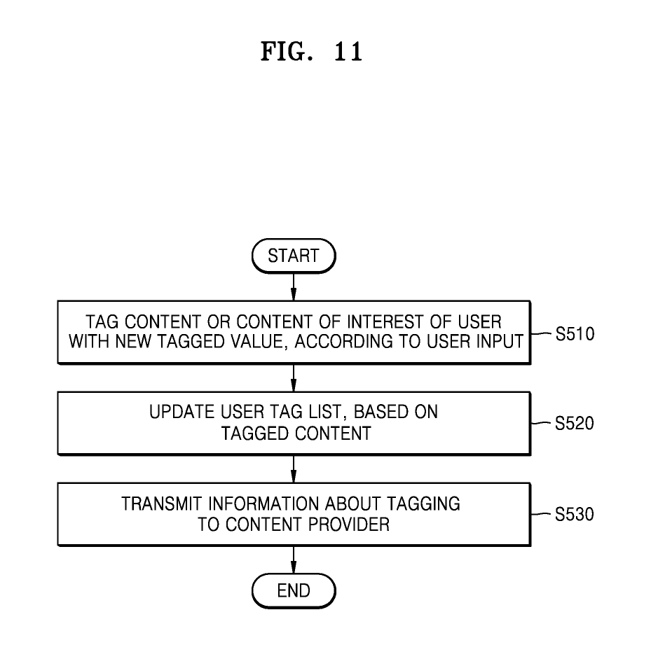

FIG. 11 is a flowchart illustrating an example method in which the electronic apparatus 1000 tags a new tag value to content according to a user input.

Referring to FIG. 11, in operation S510, the electronic apparatus 1000 may tag a new tagged value to content or content of interest of a user, based on a user input made via a screen of the electronic apparatus 1000 on which the content or content of interest of the user is displayed. According to some examples, the electronic apparatus 1000 may receive a user input of selecting a text or image included in the user content. The electronic apparatus 1000 may tag the text or image selected based on the user input to the user content.

The electronic apparatus 1000 may display a tagging UI for adding a new tagged value to the content or content of interest of the user. For example, the electronic apparatus 1000 may tag the new text or image to the content or content of interest of the user based on a user input made via the tagging UI.

In operation S520, the electronic apparatus 1000 may update a user tag list, based on the tagged content. The electronic apparatus 1000 may update a content management table and an index table as the new tagged value is added to the content. The user tag list may include the added tagged value as the index table is updated.

In operation S530, the electronic apparatus 1000 may transmit information about the tagging to the content provider 2000. The information about the tagging may include, for example, meta information regarding the tagged content, the tagged value, and ID information of the user of the electronic apparatus 1000 having subscribed to the content provider 2000. For example, the electronic apparatus 1000 may transmit the information about the tagging via an API provided by the content provider 2000. The content provider 2000 may also perform tagging, based on the information about the tagging.

The electronic apparatus 1000 may delete or edit the user content based on the user input made via the screen on which the user content is displayed. The electronic apparatus 1000 may transmit information about the deletion or edition to the content provider 2000. Accordingly, the user may manage the user content via a single application without executing applications provided by different content providers 2000.

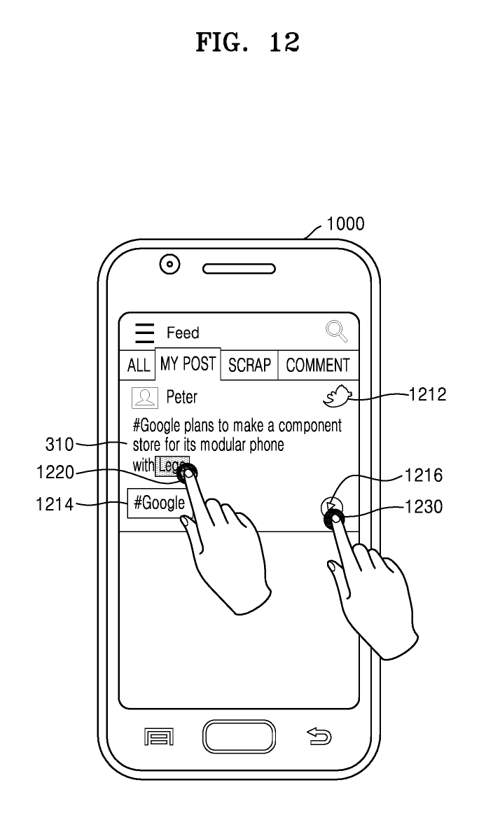

FIG. 12 illustrates an example in which the electronic apparatus 1000 tags a text included in the content 310 of the user of FIG. 3A to the content 310 of the user.

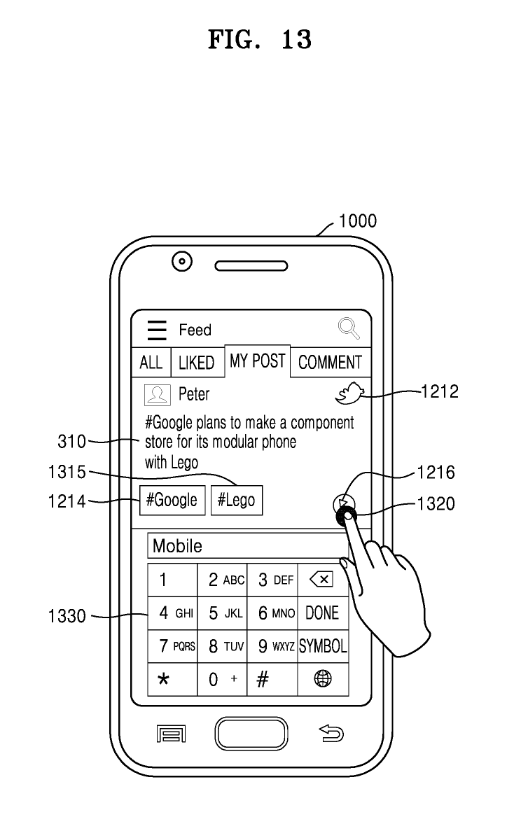

Referring to FIG. 12, the electronic apparatus 1000 may display the content 310 of the user of FIG. 3A, a content provider icon 1212 of a content provider that provides the content 310 of the user, a “#Google” image 1214 corresponding to a tagged value “Google” extracted from the content 310 of the user, and a tagging UI 1216 for tagging the content 310 of the user. The electronic apparatus 1000 may receive a user input 1220 of selecting a text “Lego” included in the content 310 of the user. The electronic apparatus 1000 may receive a touch input 1230 from the user via the tagging UI 1216. In response to the touch input 1230 of the user via the tagging UI 1216, the electronic apparatus 1000 may tag the text “Lego” to the content 310 of the user. Accordingly, as illustrated in FIG. 13, the electronic apparatus 1000 may display a “#Lego” image 1315 corresponding to the new tagged value “Lego” included in the content 310 of the user.

The electronic apparatus 1000 may receive a user input of touching the tagging UI 1216 for a critical time period or more. For example, the electronic apparatus 1000 may delete the content 310 of the user. As the content 310 of the user is deleted, the electronic apparatus 1000 may update a content management table and a user tag list.

FIG. 13 illustrates an example in which the electronic apparatus 1000 tags a new tagged value to the content 310 of the user of FIG. 3A.

Referring to FIG. 13, the electronic apparatus 1000 may receive a user input 1320 of selecting the tagging UI 1216, without selecting a text or image included in the content 310 of the user of FIG. 3A. For example, the electronic apparatus 1000 may display a keypad UI 1330 for generating a new tagged value. The user may input a desired tagged value via the keypad UI 1330. For example, the electronic apparatus 1000 may receive a user input of inputting “Mobile”. Accordingly, the electronic apparatus 1000 may tag the input “Mobile” to the content 310 of the user.

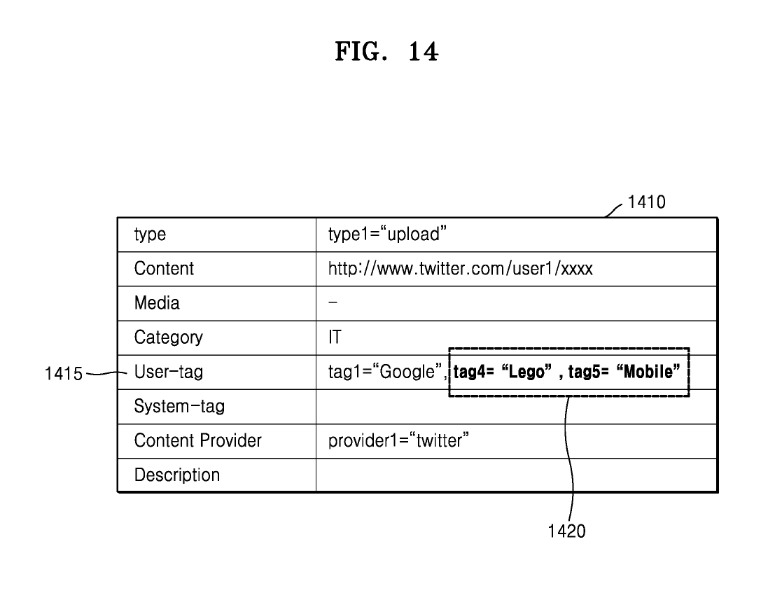

FIG. 14 illustrates an example in which the electronic apparatus 1000 updates a content management table.

Referring to FIG. 14, as the user adds the new tagged values “Lego” and “Mobile” to the content 310 of the user of FIG. 3A, the electronic apparatus 1000 may update the content management table 320 of FIG. 3B. A user tag field 1415 of an updated content management table 1410 may include “Lego” and “Mobile” 1420.

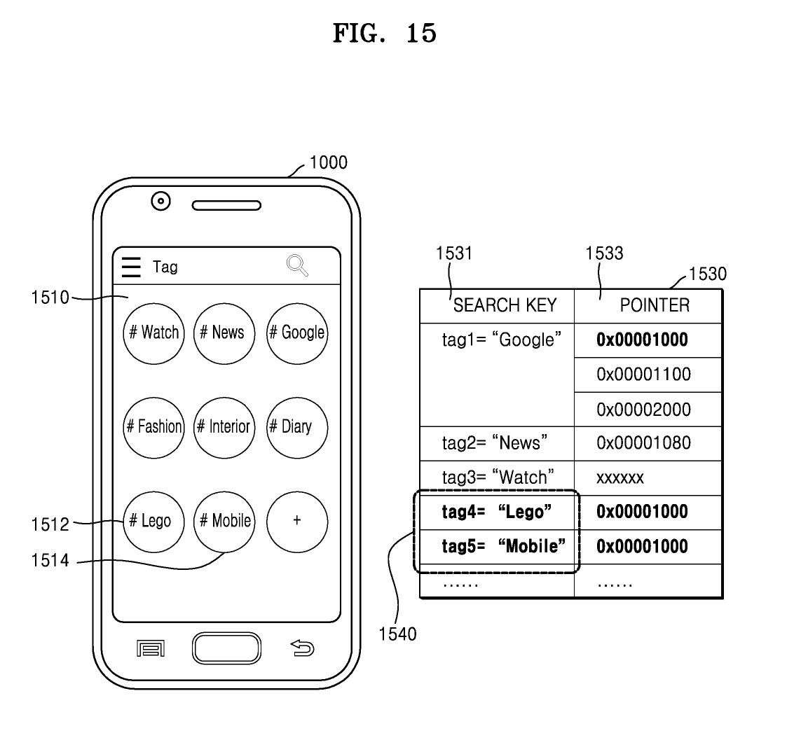

FIG. 15 illustrates an example in which the electronic apparatus 1000 updates a user tag list based on an updated content management table.

Referring to FIG. 15, the electronic apparatus 1000 may update the index table 430 of FIG. 4, based on the updated content management table 1410 of FIG. 14. A search key field 1531 of an updated index table 1530 may include new tagged values “Lego” and “Mobile” 1540. A pointer field 1533 of the updated index table 1530 may include address values where updated content management tables 1410 of FIG. 14 corresponding to the new tag values “Lego” and “Mobile” 1540 are stored.

As new tag values are added to the search key field 431 of the index table 430 of FIG. 4, the electronic apparatus 1000 may display a user tag list 1510 further including the added tagged values. Accordingly, the user tag list 1510 may include a “# Lego” image 1512 and a “#Mobile” image 1514 corresponding to the new tagged values.

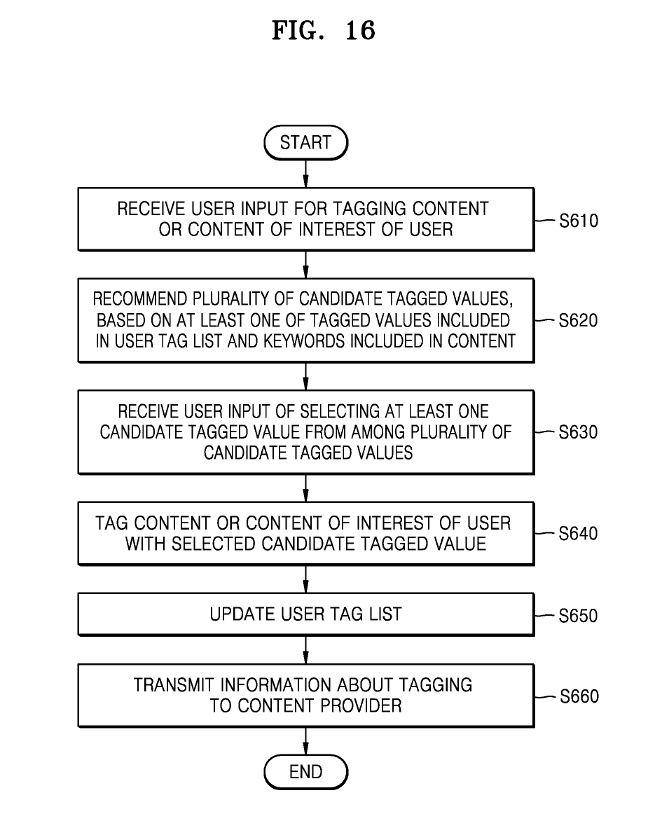

FIG. 16 is a flowchart illustrating an example method in which the electronic apparatus 1000 recommends a tagged value for tagging content.

Referring to FIG. 16, in operation S610, the electronic apparatus 1000 may receive a user input for tagging content or content of interest to a user. For example, the electronic apparatus 1000 may provide a UI for tagging content or content of interest of a user.

In operation S620, the electronic apparatus 1000 may recommend a plurality of candidate tagged values, based on at least one of tagged values included in a user tag list and keywords included in the content. The keywords included in the content may, for example, be extracted from metadata of the content. For example, the keywords included in the content may a text representing the category of the content, a text repeatedly shown on the content, texts associated with the tagged values included in the user tag list, a text representing the category of a text (or image) linked to the content, and a text repeatedly shown on the text (or image) linked to the content. However, examples are not limited thereto.

The electronic apparatus 1000 may recommend the tagged values included in the user tag list as the plurality of candidate tagged values. The electronic apparatus 1000 may recommend the keywords included in the content or content of interest of the user as the candidate tagged values. The electronic apparatus 1000 may recommend, as the candidate tagged values, search formulas searched by the user a critical number of times or more, based on search history information of the user. The electronic apparatus 1000 may recommend tagged values recently used by the user as the candidate tagged values, but embodiments are not limited thereto. The electronic apparatus 1000 may display a candidate tag list including the candidate tagged values, in order to recommend the candidate tagged values.

In operation S630, the electronic apparatus 1000 may receive a user input of selecting at least one candidate tagged value from among the plurality of candidate tagged values.

In operation S640, the electronic apparatus 1000 may tag the selected candidate tagged value to the content or content of interest of the user.

In operation S650, the electronic apparatus 1000 may update the user tag list, based on the selected candidate tagged value. For example, as a tagged value is added to content, the electronic apparatus 1000 may update a content management table and an index table corresponding to the tagged content. Accordingly, the electronic apparatus 1000 may provide the user with the user tag list including the new added tagged value.

In operation S660, the electronic apparatus 1000 may transmit information about the tagging to the content provider 2000. The information about the tagging may include, for example, meta information regarding the tagged content, the tagged value, and ID information of the user of the electronic apparatus 1000 having subscribed to the content provider 2000. Accordingly, the content provider 2000 may also perform tagging, based on the information about the tagging.

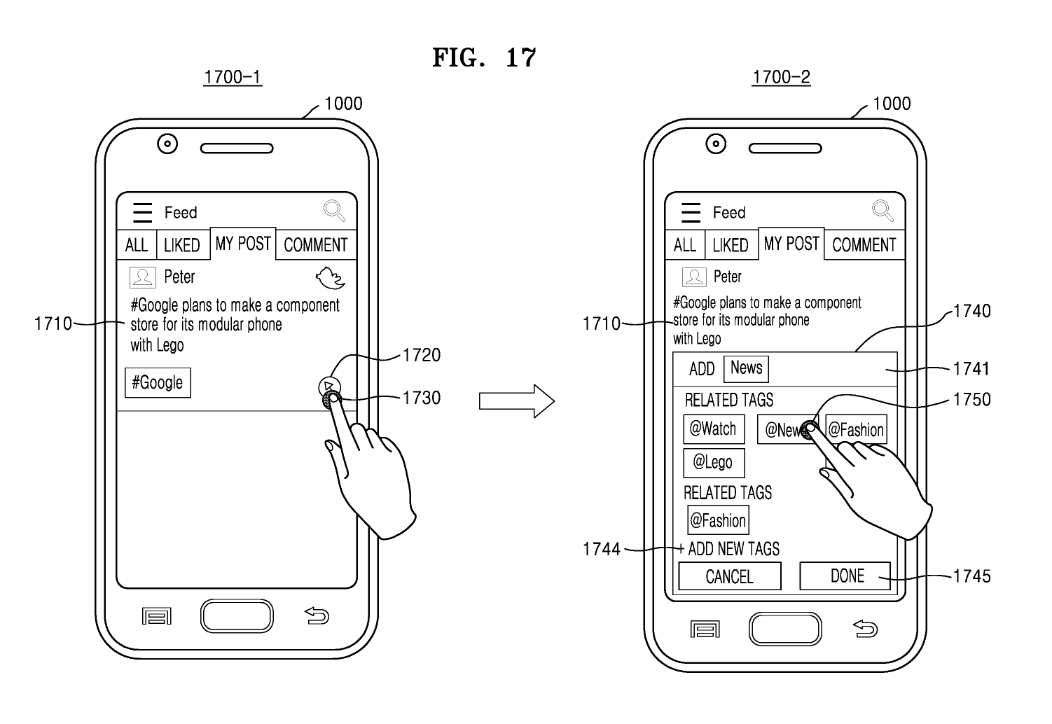

FIG. 17 illustrates an example in which the electronic apparatus 1000 recommends a candidate tagged value and tags the recommended candidate tagged value to content of a user.

Referring to FIG. 17, the electronic apparatus 1000 may provide content 1710 of a user and a tagging UI 1720 for tagging the content 1710 of the user (1700-1). The electronic apparatus 1000 may receive a user input 1730 via the tagging UI 1720.

In response to the user input 1730, the electronic apparatus 1000 may display a candidate tag list window 1740 including candidate tagged values (1700-2). The candidate tagged values may be, for example, tagged values (for example, “Watch”, “News”, and “Fashion”) included in a user tag list, and keywords (for example, “Lego”) included in the user content. The candidate tagged values may be tagged values recently used by the user. The candidate tagged values may include synonyms of keywords included in the content 1710 of the user, words that are superordinate to the keywords, and words related with the keywords. For example, the electronic apparatus 1000 may provide words not included in the user content 1710 as the candidate tagged values, based on dictionary information about keywords.

The electronic apparatus 1000 may receive a user input 1750 of selecting at least one candidate tagged value (for example, “News”) via the candidate tag list window 1740. The electronic apparatus 1000 may select an ‘ADD NEW TAGS’ 1744 in order to input a new tagged value. When a candidate tagged value or a new tagged value is selected, the electronic apparatus 1000 may display the selected tagged value via an ‘ADD’ field 1741. In response to a user input of a DONE button 1745, the electronic apparatus 1000 may tag tagged values displayed on the ‘ADD’ field 1741 to the content 1710 of the user.

The candidate tagged values may be listed in a predetermined order. For example, the candidate tagged values may be listed in a descending order of relations with the user content 1710. The candidate tagged values may be listed in an order recently used by the user.

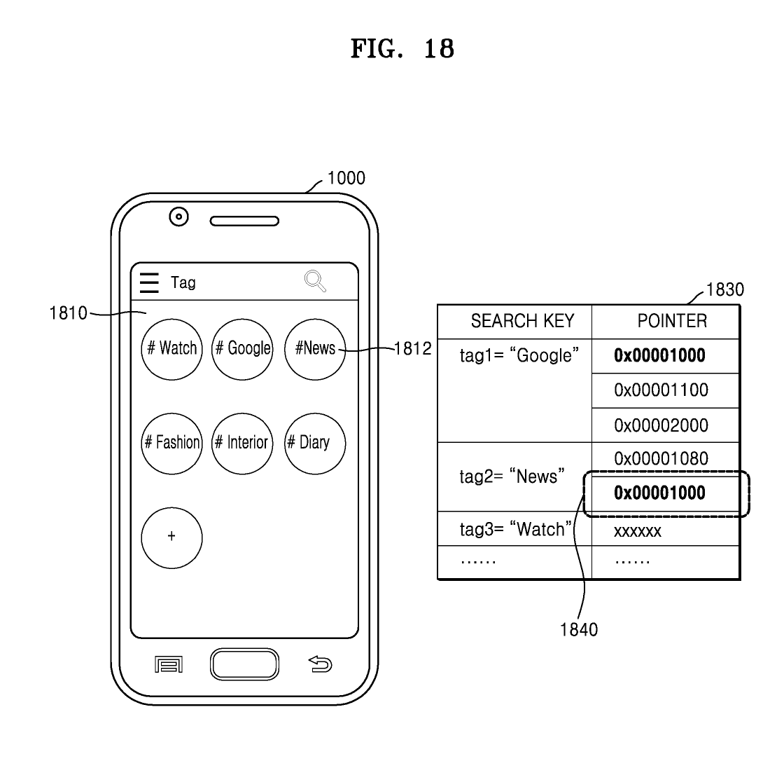

FIG. 18 illustrates an example in which a user tag list is updated as the electronic apparatus 1000 tags content of a user with a recommended candidate tagged value.

Referring to FIG. 18, the electronic apparatus 1000 may update a content management table and an index table 1830, as the candidate tagged value “News” recommended in FIG. 17 is tagged to the content 1710 of the user of FIG. 17. For example, since the recommended candidate tagged value “News” is not a new tagged value, only a pointer field 1840 mapped with tag2=“News” in a search key field of the index table 1830 may be added. Accordingly, the electronic apparatus 1000 may display a user tag list 1810 that is the same as a previous user tag list.

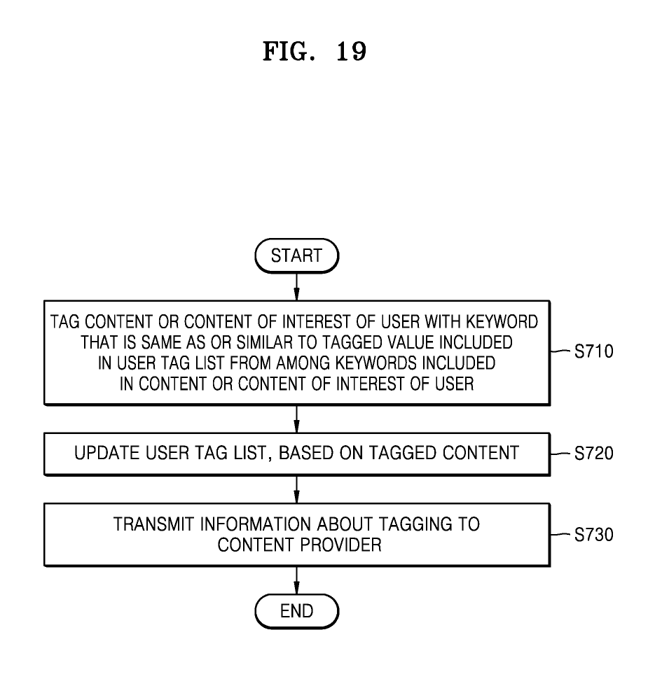

FIG. 19 is a flowchart illustrating an example method in which the electronic apparatus 1000 automatically tags content.

Referring to FIG. 19, in operation S710, the electronic apparatus 1000 may tag content or content of interest of a user with a keyword that is the same as or similar to a tagged value included in a user tag list from among keywords included in the content or content of interest of the user. The keywords included in the content may be extracted from metadata of the content. For example, the keywords included in the content may a text representing the category of the content, a text repeatedly shown on the content, texts associated with the tagged values included in the user tag list, a text representing the category of a text (or image) linked to the content, and a text repeatedly shown on the text (or image) linked to the content. However, examples are not limited thereto. The keyword similar to the tagged value may include, for example, a word having the same meaning as the tagged value but being different from the tagged value, a singular or plural form of the tagged value, or an abbreviation of the tagged value.

When a text (or image) included in the content is repeated a critical number of times or more within the content, the electronic apparatus 1000 may tag the repeated keyword to the content.

In operation S720, the electronic apparatus 1000 may update the user tag list, based on the tagged content. The electronic apparatus 1000 may update a content management table and an index table as a tagged value is added to the content. Accordingly, the user tag list may be updated as the index table is updated.

In operation S730, the electronic apparatus 1000 may transmit information about the tagging to the content provider 2000. The information about the tagging may include, for example, meta information regarding the tagged content, the tagged value, and ID information of the user of the electronic apparatus 1000 having subscribed to the content provider 2000. Accordingly, the content provider 2000 may also perform tagging, based on the information about the tagging.

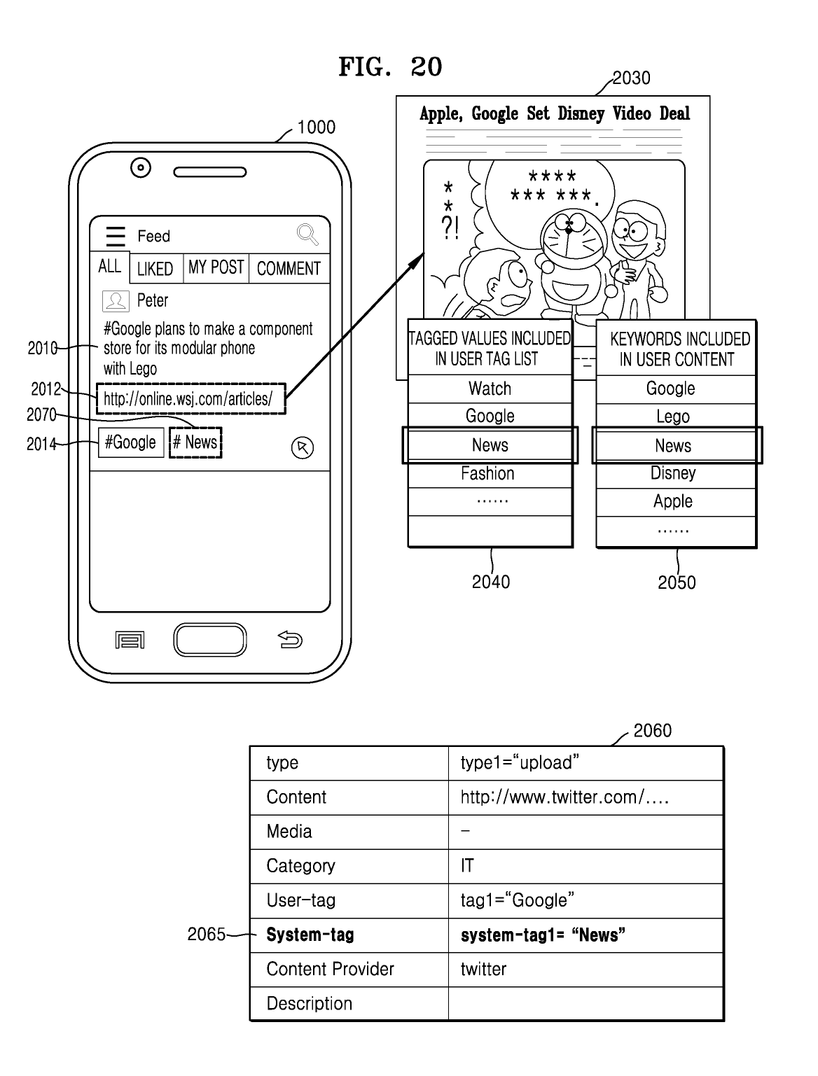

FIG. 20 illustrates an example in which the electronic apparatus 1000 automatically tags content of a user.

Referring to FIG. 20, content 2010 of a user may include a text #Google corresponding to a hashtag, and a link address value 2012. Accordingly, the electronic apparatus 1000 may extract a tagged value “Google” from the text “#Google” and display a “#Google” image 2014 corresponding to the tagged value “Google” together with the content 2010 of the user.

The electronic apparatus 1000 may determine, as a new tag value, “News” which is the same as a tagged value “News” among tagged values 2040 included in a user tag list from among keywords 2050 included in the user content (for example, “Lego”, “Google”, and “News”). The electronic apparatus 1000 may extract a tagged value “News” from the text “#News” and display a “#News” image 2070 corresponding to the tagged value “News” together with the content 2010 of the user. The keywords 2050 included in the user content may include texts “Google” and “Lego” included in the content 2010 of the user, “News” which is the category of linked content 2030, and texts “Disney” and “Apple” included in the linked content 2030.

The electronic apparatus 1000 may add a new tagged value “News” to a content management table 2060. For example, “News” may be added to a system-tag field 2065 of the content management table 2060. The electronic apparatus 1000 may update an index table. For example, the index table may be produced by indexing the content management table 2060 by using a user tag field and a system tag field. Accordingly, the electronic apparatus 1000 may display a user tag list including user tagged values and system tagged values included in a search key field of the index table.

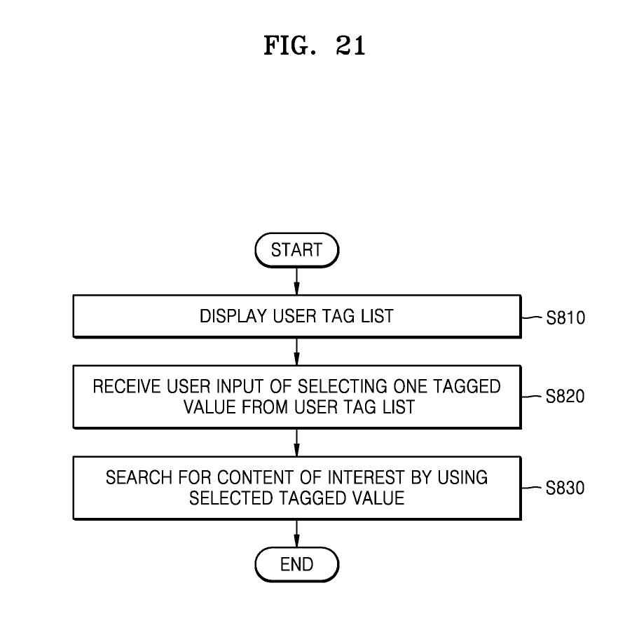

FIG. 21 is a flowchart illustrating an example method in which the electronic apparatus 1000 searches for content of interest.

Referring to FIG. 21, in operation S810, the electronic apparatus 1000 may display a user tag list. For example, the electronic apparatus 1000 may display a user tag list including images respectively corresponding to the tagged values included in an index table. In operation S820, the electronic apparatus 1000 may receive a user input of selecting one tagged value from the user tag list.

In operation S830, the electronic apparatus 1000 may search for content of interest by using the selected tagged value. The electronic apparatus 1000 may display a result of the search. The content of interest may be content found using a tagged value included in the user tag list from among content items that are provided by content providers 2000 to which the user of the electronic apparatus 1000 has subscribed or content providers 2000 to which the user of the electronic apparatus 1000 has not subscribed.

According to some examples, a user may store an ID value, an address (for example, link information), and the like of a specific content provider in the electronic apparatus 1000 in order to receive the content of interest. The user may also store the ID value, address, and the like of the content provider for each tagged value. The electronic apparatus 1000 may request a pre-stored content provider for content including the tagged value, based on the ID value or address of the pre-stored content provider. The electronic apparatus 1000 may receive the content of interest from the pre-stored content provider.

For example, the content of interest may be content found from content items that are provided by a news content provider. The content of interest may be content found from content items that are provided by an RSS provider. For example, the electronic apparatus 1000 may search for content included in an RSS feed received by the electronic apparatus 1000 by using the tagged value, and provide a result of the search to the user.

According to some examples, the content of interest may be content found from user content items by using the tag value. The electronic apparatus 1000 may acquire the user content including the tagged value from the index table.

The content of interest may be content found from content items of other users who are friends of the user of the electronic apparatus 1000.

The electronic apparatus 1000 may automatically tag the tagged value used for the search to each content of interest. As described above with reference to FIGS. 11-20, the electronic apparatus 1000 may tag a new tagged value to the content of interest. The electronic apparatus 1000 may update the user tag list as the tagging is performed. Thereafter, the electronic apparatus 1000 may provide the user with the tagged content of interest as the user content.

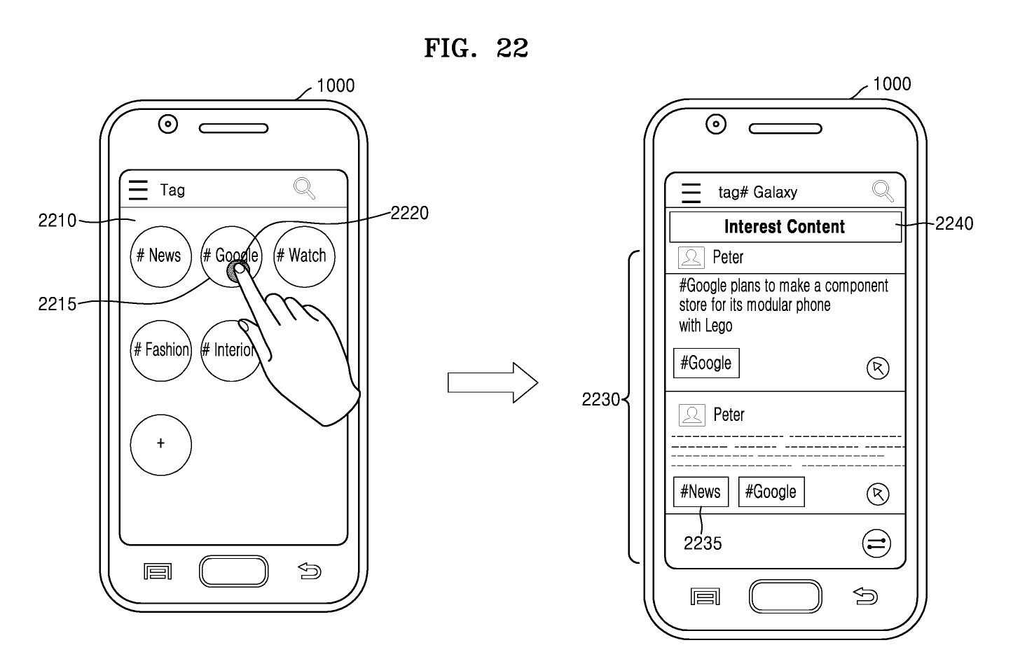

FIG. 22 illustrates an example in which the electronic apparatus 1000 displays content of interest using a user tag list.

Referring to FIG. 22, the electronic apparatus 1000 may display a user tag list 2210. For example, when the electronic apparatus 1000 receives a touch input 2220 regarding an image 2215 marked with a tagged value (e.g., “Google”) from a user, the electronic apparatus 1000 may display a subordinate menu for providing content of interest. For example, the subordinate menu may include a field (“My Feed”) for providing content of interest found using a tagged value from among user content items, and a field (“Interest Content”) for providing the content of interest acquired from a pre-stored content provider.

According to an example, the electronic apparatus 1000 may receive a user input 2220 of selecting a “Google” field. In response to the user input 2220, the electronic apparatus 1000 may search for content of interest of a user including a selected tagged value “Google”, based on an index table. The electronic apparatus 1000 may display found content of interest 2230 of the user, which is a result of the search.

The found content of interest 2230 of the user may include another tagged value (for example, ‘News’). When the electronic apparatus 1000 receives a user input with respect to a “#News” image 2235 corresponding to the other tagged value “News”, the electronic apparatus 1000 may display content of interest of the user regarding the tagged value “News”.

The electronic apparatus 1000 may provide an content of interest search UI 2240 for providing content of interest from a pre-stored content provider, via the screen on which user content found using the tagged value “Google” is displayed. In response to a user input regarding the content of interest search UI 2240, the electronic apparatus 1000 may request for content including the tagged value “Google” by using the ID value or link information of the pre-stored content provider, and receive a result of the request. When there are a plurality of pre-stored content providers, the electronic apparatus 1000 may display content of interest of the user received from each of the pre-stored content providers.

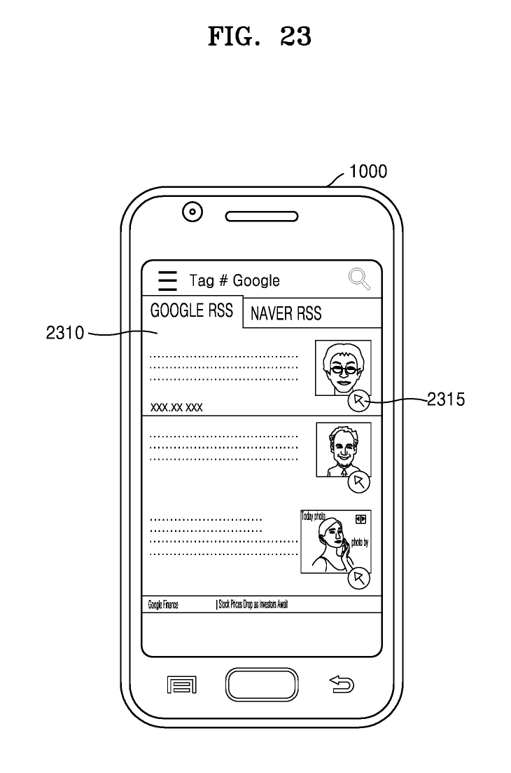

FIG. 23 illustrates an example in which the electronic apparatus 1000 displays content of interest of a user.

As illustrated in FIG. 23, the electronic apparatus 1000 may display content of interest items 2310 of a user found using a tagged value “Google” from content items included in each RSS feed to which the user subscribes. The electronic apparatus 1000 may provide a tagging UI 2315 on the screen provided with the content of interest items 2310. The user may tag a new tagged value to the found content of interest items 2310, via the tagging UI 2315. The electronic apparatus 1000 may update a user tag list such that the user tag list includes the new tagged value included in the found content of interest items 2310. Thereafter, the user may be provided with the found content of interest items 2310 as user content.

According to some examples, the electronic apparatus 1000 may transmit the content of interest items 2310 of the user to an external apparatus. For example, the electronic apparatus 1000 may transmit the content of interest items 2310 to devices of other users who are friends of the user. The electronic apparatus 1000 may transmit the content of interest items 2310 to devices of other users who belong to a group produced by the user.

The electronic apparatus 1000 may transmit some of the content of interest items 2310 of the user to an external apparatus. For example, the electronic apparatus 1000 may transmit, to an external apparatus, content included in a specific category (for example, a picture, a text, an image, a moving picture, or a link) from among the content of interest items 2310 of the user. The electronic apparatus 1000 may transmit content selected by the user from among the content of interest items 2310 of the user to an external apparatus.

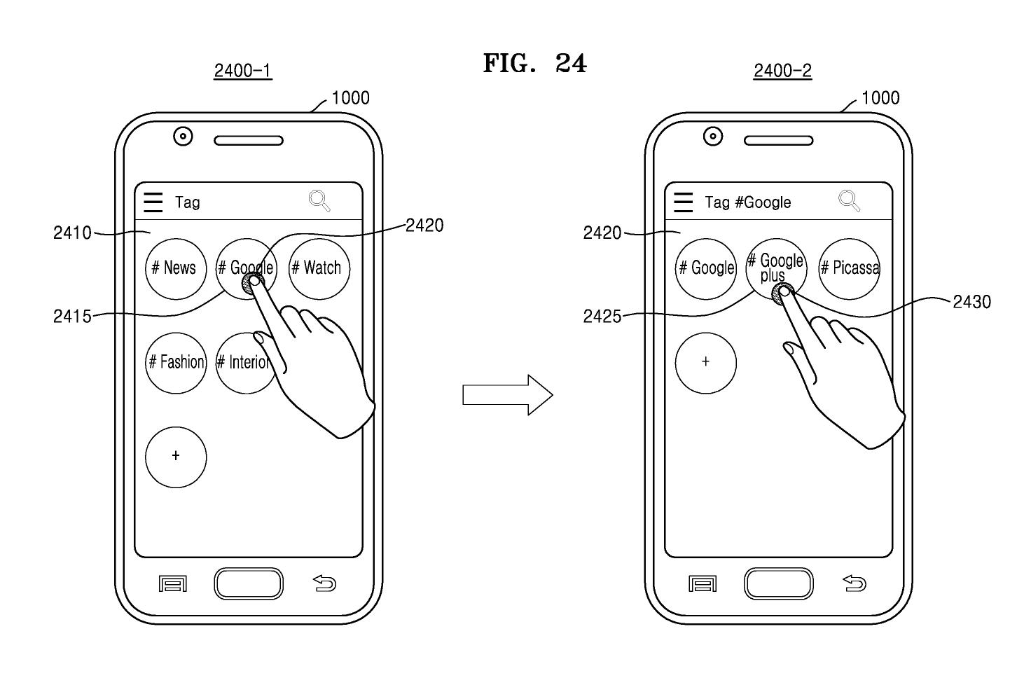

FIG. 24 illustrates an example in which the electronic apparatus 1000 searches for content of interest by using a user tag list including an upper tagged value and a lower tagged value.

According to some examples, the electronic apparatus 1000 may provide a user tag list including an upper tagged value and a lower tagged value. For example, the electronic apparatus 1000 may determine an upper tagged value from among tagged values that are semantically connected to one another, based on a semantic similarity between tagged values extracted from content of a user. The electronic apparatus 1000 may arrange the tagged values hierarchically by determining remaining tag values as lower tagged values of the upper tagged value. The electronic apparatus 1000 may produce a user tag list including an upper tagged value and lower tagged values, based on an input received from the user.

Referring to FIG. 24, the electronic apparatus 1000 may extract tagged values “Google”, “Google plus”, and “Picasa” from the user content. For example, the electronic apparatus 1000 may determine the tagged value “Google” from among the tagged values “Google”, “Google plus”, and “Picasa”, which are semantically similar to one another, as an upper tagged value and determine remaining tagged values as lower tagged values. For example, the electronic apparatus 1000 may display a first user tag list 2410 including an image 2415 marked with a representative tagged value “Google” (2400-1). The first user tag list 2410 may not include lower tagged values.

In response to a user input with respect to the image 2415 marked with the tagged value “Google”, the electronic apparatus 1000 may display a second user tag list 2420 including images marked with an upper tagged value “Google” and lower tagged values “Google plus” and “Picasa” (2400-2).

If a lower tagged value having the tagged value “Google plus” as an upper tagged value exists, the electronic apparatus 1000 may display a third user tag list including a lower tagged value of the tagged value “Google plus” in response to a user input 2430 regarding an image 2425 marked with the tagged value “Google plus”. If a lower tagged value of the tagged value “Google plus” does not exist, the electronic apparatus 1000 may display content of a user including the tagged value “Google plus” in response to the user input 2430 regarding the image 2425 marked with the tagged value “Google plus”.

According to some examples, the electronic apparatus 1000 may prioritize the tagged values included in a user tag list. For example, the electronic apparatus 1000 may prioritize the tagged values, based on the number of times each tagged value is selected by the user. The electronic apparatus 1000 may give priority to a recently used tagged value. The priority of each tagged value may be given by the user of the electronic apparatus 1000. The priority of an upper tagged value may be determined based on priorities given to lower tagged values. The electronic apparatus 1000 may list the tagged values according to the priority of each tagged value.

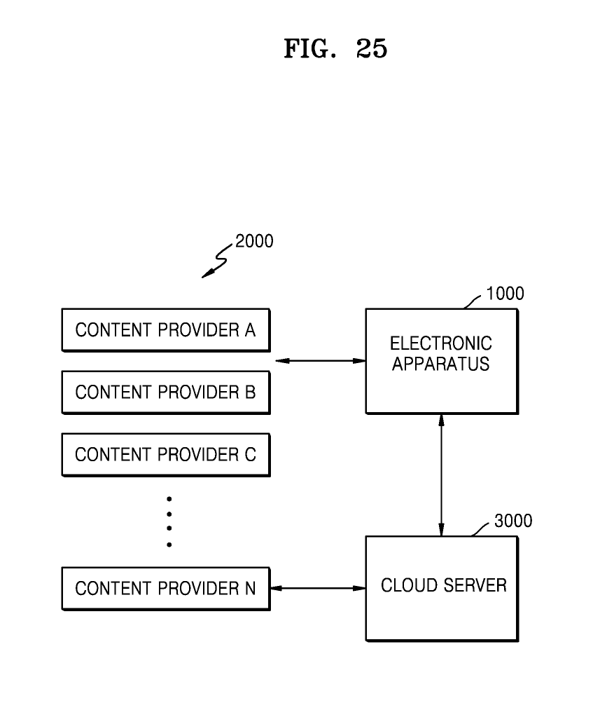

FIG. 25 is a block diagram illustrating a content providing system including a cloud server. Referring to the example illustrated FIG. 25, the electronic apparatus 1000 may acquire content of a user from content providers 2000. The electronic apparatus 1000 may transmit an ID value of the electronic apparatus 1000 and information about the user content to a cloud server 3000. The ID value of the electronic apparatus 1000 may include, for example, an ID of a user of the electronic apparatus 1000 having subscribed to the cloud server 3000, and a MAC address of the electronic apparatus 1000. The information about the user content may include at least one of meta information of the user content, an address value of the user content, and information about content providers.

The cloud server 3000 may generate a content management table for each content, based on the received ID value of the electronic apparatus 1000 and the received information about the user content. A content management table produced by the electronic apparatus 1000 may be referred to a first content management table, and a content management table produced by the cloud server 3000 may be referred to as a second content management table.

The cloud server 3000 may manage users of the cloud server 3000. For example, the cloud server 3000 may allow only users having subscribed to the cloud server 3000 to have access to the cloud server 3000. When the users of the cloud server 3000 set a friend relationship, the cloud server 3000 may allow the users having a friend relationship to share content.

In this disclosure, the cloud server 3000 may be a server that provides a service enabling users to use a specific storage space over a network. The cloud server 3000 may include a storage space over a network that is to be provided to users having subscribed to the cloud server 3000, for example, may include a cloud storage.

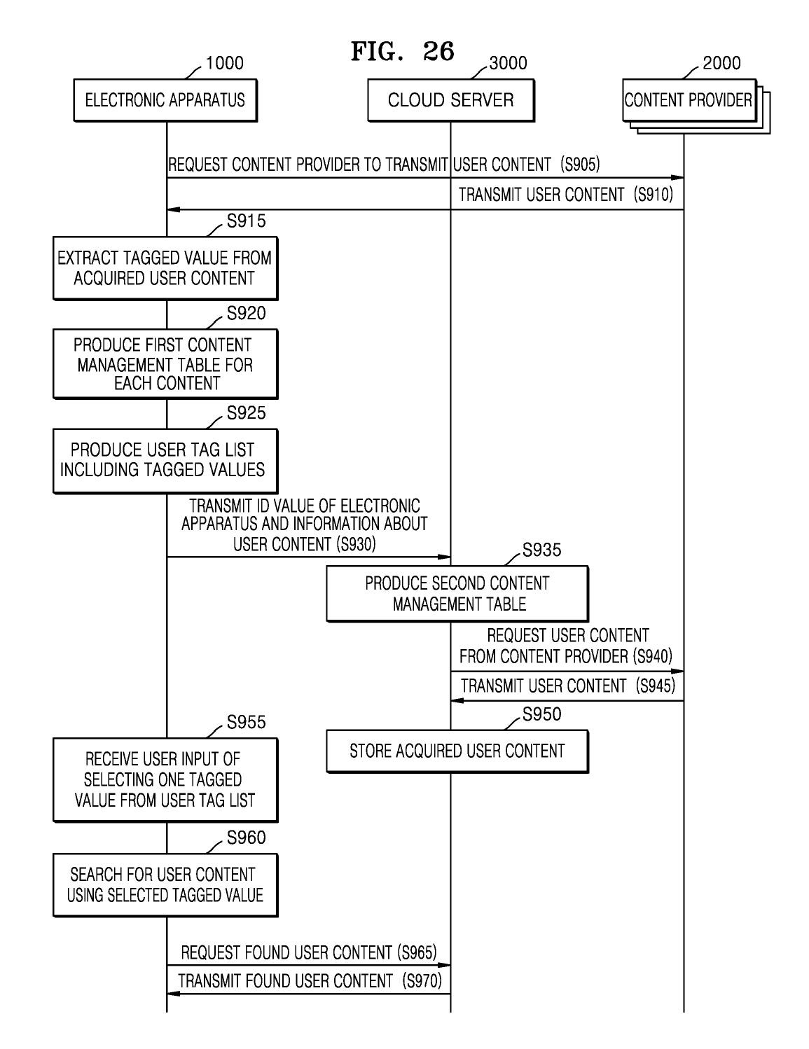

FIG. 26 is a flowchart illustrating an example method in which the electronic apparatus 1000 receives content and content of interest of a user from the cloud server 3000.

Referring to FIG. 26, the electronic apparatus 1000 may request a content provider 2000 to transmit content of a user, in operation S905. Accordingly, the content provider 2000 may transmit the user content to the electronic apparatus 1000, in operation S910. The electronic apparatus 1000 may extract a tagged value from the acquired user content, in operation S915. The electronic apparatus 1000 may produce a first content management table, based on the acquired user content and the extracted tagged value, in operation S920. The electronic apparatus 1000 may produce an index table having tagged values as a search key field, by indexing the first content management table with a tagged value. The electronic apparatus 1000 may produce a user tag list including the tagged values included in the search key field, in operation S925. The electronic apparatus 1000 may transmit an ID value of the electronic apparatus 1000 and information about the user content to the cloud server 3000, in operation S930. For example, the electronic apparatus 1000 may transmit an ID of a user of the electronic apparatus 1000 having subscribed to the cloud server 3000, and a content address field value of the first content management table to the cloud server 3000.

The cloud server 3000 may produce a second content management table, based on the received ID value of the electronic apparatus 1000 and the received information about the user content, in operation S935. If a second content management table corresponding to the received user content exists, the cloud server 3000 may update the second content management table.

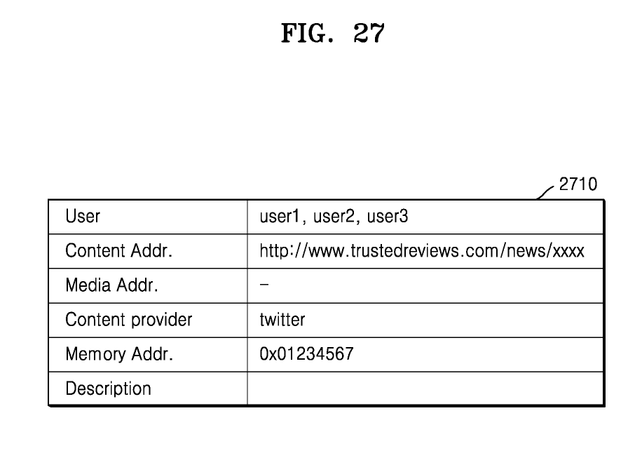

FIG. 27 illustrates an example of the second content management table that is produced by the cloud server 3000.

As illustrated in FIG. 27, the cloud server 3000 may produce a second content management table 2710 for each content. The second content management table 2710 may include at least one of a user field, a content address field, a media address field, a content provider field, a memory address field, and a description field. The user field may include IDs of different users who produce or use the same content. When the cloud server 3000 separately stores content, a memory address in the memory address field may be a memory address of the cloud server 3000 where the content has been stored.

For example, when first content is produced by user1 and used by user2 and user3, a user field of a second content management table corresponding to the first content may include user1, user2, and user3. If the cloud server 3000 receives information about user4 and the first content, the cloud server 3000 may update the second content management table 2710 corresponding to the first content. The cloud server 3000 may add user4 to the user field of the second content management table 2710.

Referring back to FIG. 26, the cloud server 3000 may request user content from the content provider 2000, based on the second content management table, in operation S940. The content provider 2000 may transmit the user content, in operation S945. After requesting the cloud server 3000 to undergo authentication, the content provider 2000 may transmit the user content when the cloud server 3000 is authorized. The cloud server 3000 may store the acquired user content, in operation S950. An address value where the user content has been stored may be stored in a memory address field of the second content management table.

In operation S955, the electronic apparatus 1000 may receive a user input of selecting one tagged value from the user tag list. In operation S960, the electronic apparatus 1000 may search for user content using the selected tagged value. The electronic apparatus 1000 may search for information about the user content including the selected tagged value from an index table. The electronic apparatus 1000 may transmit information about found content to the cloud server 3000, in operation S965. For example, the electronic apparatus 1000 may transmit a content address field value of a first content management table corresponding to the found content to the cloud server 3000. The cloud server 3000 may transmit the user content stored therein to the electronic apparatus 1000, based on the second content management table, in operation S970.

For example, since the cloud server 3000 separately stores the user content, the electronic apparatus 1000 may acquire the user content from the cloud server 3000 even when the user content is deleted by the content provider 2000.

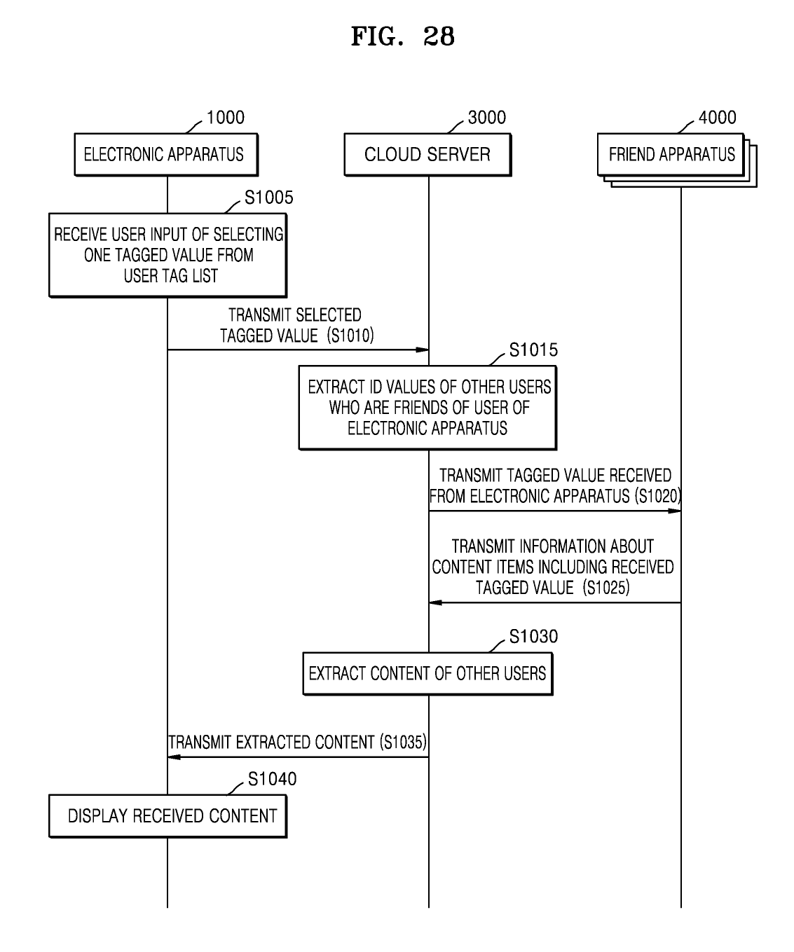

FIG. 28 is a flowchart illustrating an example method in which the electronic apparatus 1000 searches for content items of other users who are friends of a user of the electronic apparatus 1000.

Referring to FIG. 28, in operation S1005, the electronic apparatus 1000 may receive a user input of selecting one tagged value from a user tag list. The electronic apparatus 1000 may transmit the selected tagged value to the cloud server 3000, in operation S1010.

The cloud server 3000 may extract ID values of the other users who are friends of the user of the electronic apparatus 1000, in operation S1015. The other users who are friends of the user of the electronic apparatus 1000 may include at least one of other users set as friends of the user of the electronic apparatus 1000 over the cloud server 3000, other users who belong to the group to which the user of the electronic apparatus 1000 belongs, and other users included in a user list within a phone book of the user of the electronic apparatus 1000. However, examples are not limited thereto.

The cloud server 3000 may transmit the tagged value received from the electronic apparatus 1000 to friend apparatuses 4000, by using the extracted ID values, in operation S1020. The friend apparatuses 4000 may be electronic apparatuses that are used by the other users who are friends of the user of the electronic apparatus 1000. When the friend apparatuses 4000 have content items including the received tagged value, the friend apparatuses 4000 may transmit information about the content items including the received tagged value to the cloud server 3000, in operation S1025. For example, the friend apparatuses 4000 may transmit ID values of the friend apparatuses 4000 and address values of the content items including the received tagged value to the cloud server 3000.

The cloud server 3000 may extract content of the other users stored in the cloud server 3000, based on the received information about the content, in operation S1030. The cloud server 3000 may transmit the extracted content to the electronic apparatus 1000, in operation S1035. The electronic apparatus 1000 may display the received content, in operation S1040. The received content may be content items of the other users including the tagged value selected by the electronic apparatus 1000.

After operation S1015, the cloud server 3000 may transmit information about the other users who are friends of the user of the electronic apparatus 1000 to the electronic apparatus 1000. For example, according to a user input of selecting at least one of the other users, the electronic apparatus 1000 may request the selected users for content.

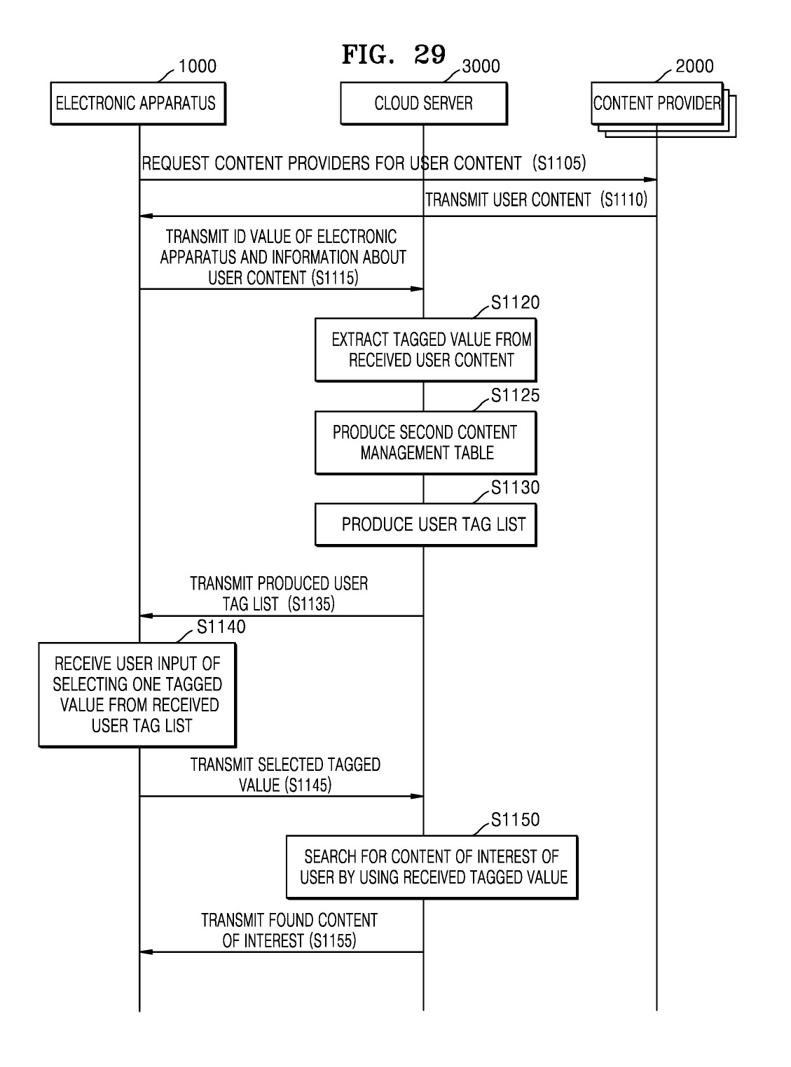

FIG. 29 is a flowchart illustrating an example method in which the electronic apparatus 1000 receives content of a user and content of interest of the user from the cloud server 3000.

Referring to FIG. 29, the electronic apparatus 1000 may request content providers 2000 for content of a user, in operation S1105. The content providers 2000 may transmit the user content to the electronic apparatus 1000, in operation S1110. The electronic apparatus 1000 may transmit an ID value of the electronic apparatus 1000 and information about the user content to the cloud server 3000, in operation S1115. For example, the electronic apparatus 1000 may transmit an ID of a user of the electronic apparatus 1000 having subscribed to the cloud server 3000, and the user content obtained from the content providers 2000 to the cloud server 3000. For example, the electronic apparatus 1000 may produce no first content management tables.

The cloud server 3000 may extract a tagged value from the received user content, in operation S1120. The cloud server 3000 may produce a second content management table, in operation S1125.

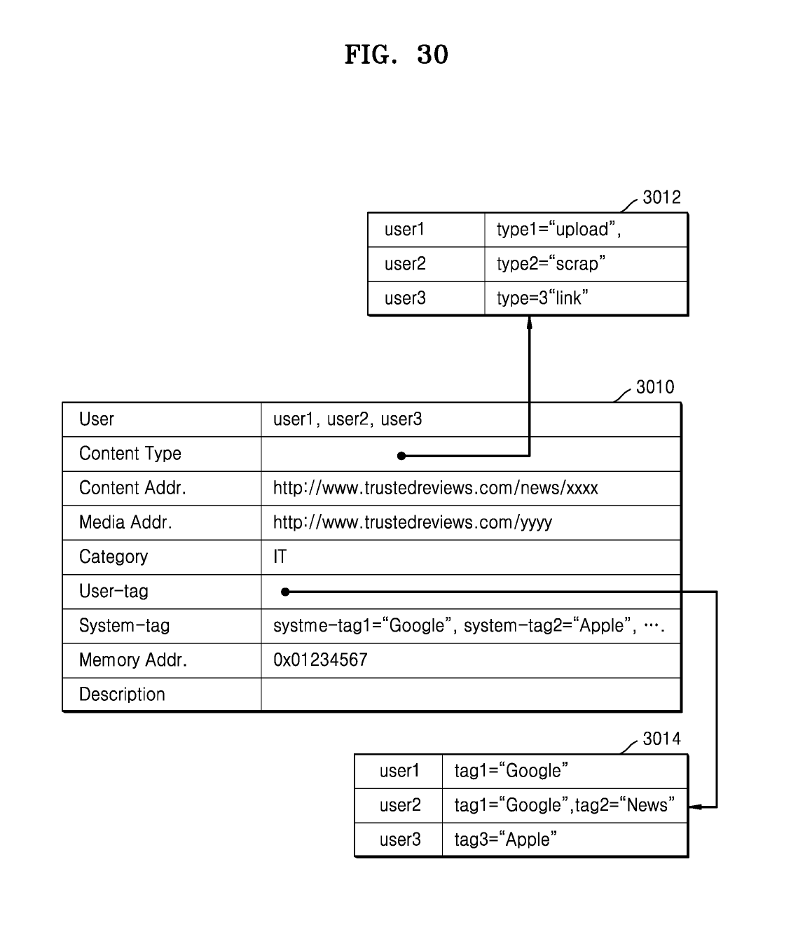

FIG. 30 illustrates an example of the second content management table that is produced by the cloud server 3000.

As illustrated in FIG. 30, the cloud server 3000 may produce a second content management table 3010. For example, the second content management table 3010 may include at least one field from among a user field, a content type field, a content address field, a media address field, a content category field, a user-tag field, a system-tag field, a content provider field, a memory address field, and a description field. The user field may include IDs of different users who produce or use the same content. The content type field and the user tag field may include information about different users who have tagged different tagged values to the same content. For example, the content type field and the user tag field may include sub tables 3012 and 3014 in which tagged values are respectively mapped with users. When the cloud server 3000 separately stores content, a memory address in the memory address field may be a memory address of the cloud server 3000 where the content has been stored.

Referring back to FIG. 29, the cloud server 3000 may produce a user tag list, based on the second content management table, in operation S1130. For example, the cloud server 3000 may index the second content management table for each user by using a user field and a user tag field. Accordingly, the electronic apparatus 1000 may produce a user tag list that includes tagged values mapped with address values of the respective second content management tables of users. The cloud server 3000 may transmit the produced user tag list to the electronic apparatus 1000, in operation S1135.

In operation S1140, the electronic apparatus 1000 may receive a user input of selecting one tagged value from the received user tag list. Accordingly, the electronic apparatus 1000 may transmit the selected tagged value to the cloud server 3000, in operation S1145. The cloud server 3000 may search for content of interest of the user by using the received tagged value, in operation S1150. For example, the cloud server 3000 may search for user content including the received tagged value from among user content items. The cloud server 3000 may transmit the content of interest of the user to the electronic apparatus 1000, in operation S1155.

The electronic apparatus 1000 may request the cloud server 3000 to transmit different user content items according to different content usage behaviors of the user. For example, the cloud server 3000 may index the second content management table by using a user field and a content type field.

The electronic apparatus 1000 may request the cloud server 3000 to transmit different user content items according to different content providers. For example, the cloud server 3000 may index the second content management table by using a user field and a content provider field.

As such, according to some examples, since the cloud server 3000 performs data processing with respect to content of a user, the electronic apparatus 1000 may decrease a processing load of the electronic apparatus 1000.

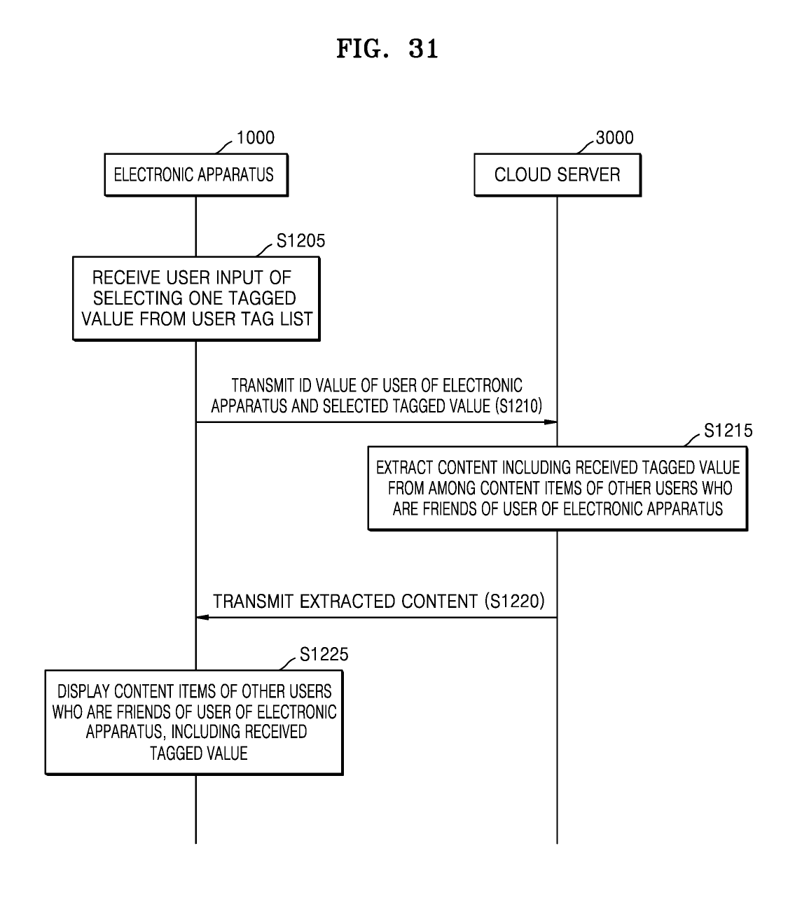

FIG. 31 is a flowchart illustrating an example method in which the electronic apparatus 1000 searches for content items of other users who are friends of a user of the electronic apparatus 1000.

According to some examples, in operation S1205, the electronic apparatus 1000 may receive a user input of selecting one tagged value from a user tag list. Accordingly, the electronic apparatus 1000 may request the cloud server 3000 for content including the selected tagged value from among content items of the other users who are friends of the user of the electronic apparatus 1000. For example, the electronic apparatus 1000 may transmit an ID value of the user of the electronic apparatus 1000 and the selected tagged value to the cloud server 3000, in operation S1210.

The cloud server 3000 may extract content including the received tagged value from among the content items of the other users who are friends of the user of the electronic apparatus 1000, in operation S1215. For example, the cloud server 3000 may extract content items of the other users including the received tagged value from a second content management table. The cloud server 3000 may extract content items of the other users who are friends of the user of the electronic apparatus 1000 from among the extract content items of the other users.

The cloud server 3000 may transmit the extracted content items to the electronic apparatus 1000, in operation S1220.

The cloud server 3000 may extract the ID values of the other users who are friends of the user of the electronic apparatus 1000, including the received tagged value, and provide the extracted ID values to the electronic apparatus 1000. The electronic apparatus 1000 may display the ID values of the other users provided by the cloud server 3000, and receive a user input of selecting one user from the displayed users. Accordingly, the electronic apparatus 1000 may request the cloud server 3000 for content including the selected tagged value from among content items of the selected other users.

The cloud server 3000 may extract content items of the other users who are friends of the user of the electronic apparatus 1000, including the received tagged value, and provide the extracted content items to the electronic apparatus 1000.

The electronic apparatus 1000 may display the received content items of the other users, in operation S1225. The electronic apparatus 1000 may use the content items of the other users as the user content by tagging a new tagged value or a tagged value included in the user tag list to the content items of the other users.

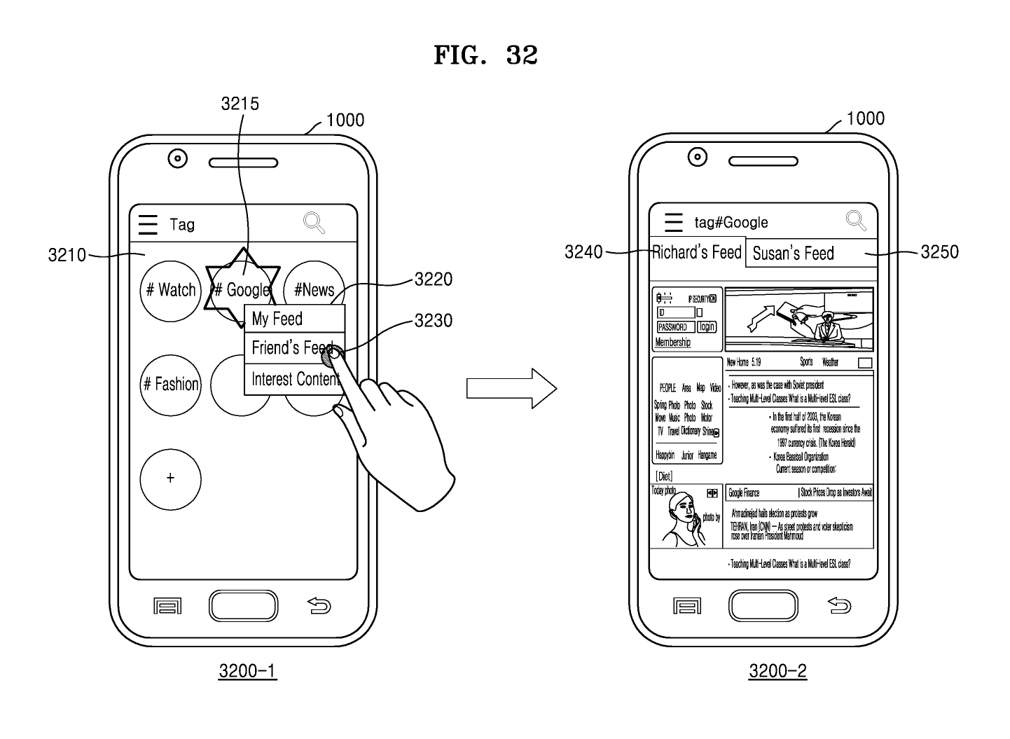

FIG. 32 illustrates an example in which the electronic apparatus 1000 provides content of interest of a user of the electronic apparatus 1000.

Referring to FIG. 32, the electronic apparatus 1000 may receive a user input regarding an image 3215 marked with a tagged value “Google” on a screen on which a user tag list 3210 is displayed. The electronic apparatus 1000 may provide content items of other users (hereinafter, referred to as friends' content) who are friends of the user of the electronic apparatus 1000, instead of providing user content including the tagged value “Google”.

For example, the electronic apparatus 1000 may display a selection UI 3220 via which the user content including the tagged value “Google” or the friends' content may be selected. The electronic apparatus 1000 may receive a user input 3230 of selecting the friends' content, via the selection UI 3220. For example, the electronic apparatus 1000 may request the cloud server 3000 for friends' content including the tagged value “Google”.

The electronic apparatus 1000 may display the friends' content received from the cloud server 3000 (3200-2). For example, the electronic apparatus 1000 may receive content including the tagged value “Google” from among content items of the other users (for example, Richard and Susan) who are friends of the user of the electronic apparatus 1000. The electronic apparatus 1000 may provide a content field for each of the other users who are friends of the user of the electronic apparatus 1000. For example, the electronic apparatus 1000 may provide a Richard's Feed 3240 and a Susan's Feed 3250.

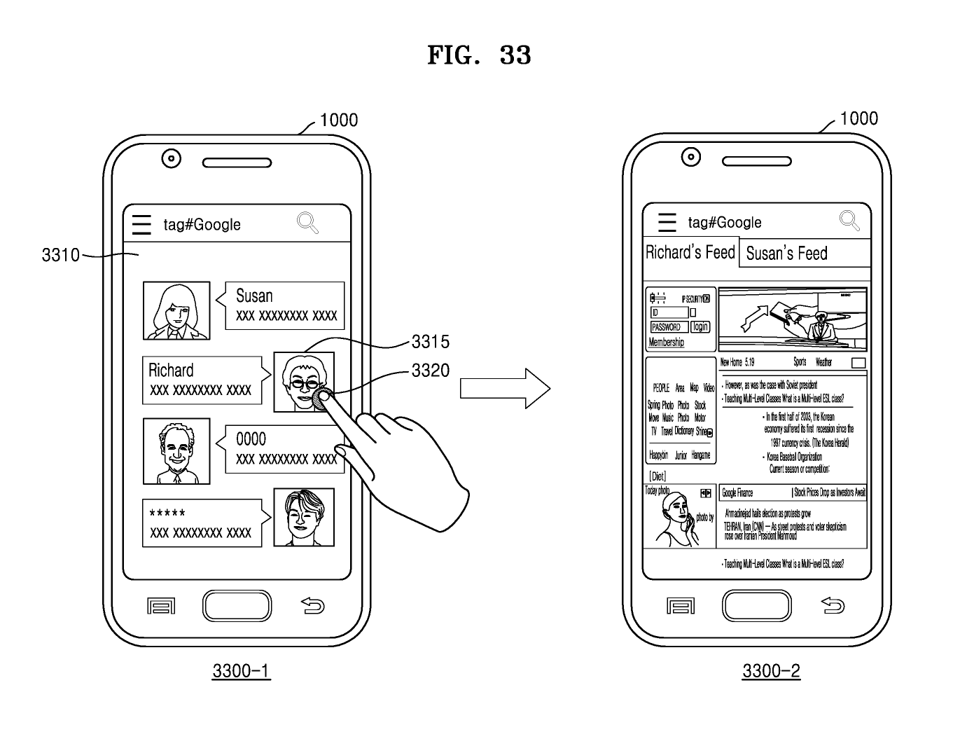

FIG. 33 illustrates an example in which the electronic apparatus 1000 provides content of interest of a user of the electronic apparatus 1000.

According to some examples, as the electronic apparatus 1000 receives the user input 3230 of selecting friends' content via the selection UI 3220 in FIG. 32, the electronic apparatus 1000 may display information about the other users having the tagged value “Google” (3300-1). The information about the users other than the user of the electronic apparatus 1000 may be provided by the cloud server 3000. The other users may be friends of the user of the electronic apparatus 1000.

The electronic apparatus 1000 may receive a user input 3320 of selecting a user (for example, Richard) 3315 from the displayed information about the other users. The electronic apparatus 1000 may receive, from the cloud server 3000, content of Richard including the tagged value “Google” from among content items of Richard. The electronic apparatus 1000 may display the received content of Richard (3300-2).

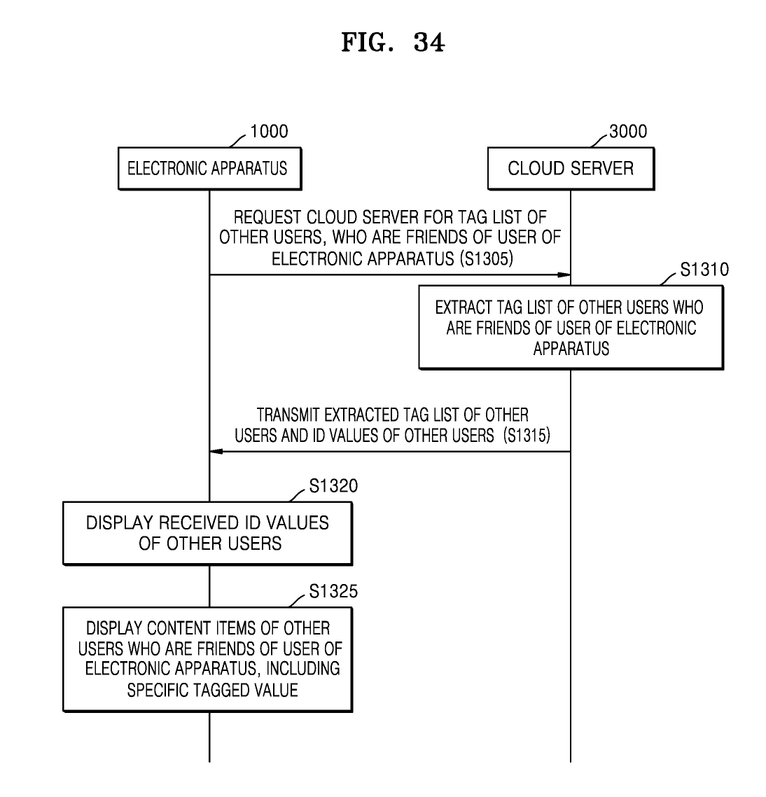

FIG. 34 is a flowchart illustrating an example method in which the electronic apparatus 1000 displays a tag list of other users who are friends of a user of the electronic apparatus 1000.

Referring to FIG. 34, the electronic apparatus 1000 may request the cloud server 3000 for the tag list of the other users, who are friends of the user of the electronic apparatus 1000, in operation S1305. Accordingly, the cloud server 3000 may extract the tag list of the other users who are friends of the user of the electronic apparatus 1000, in operation S1310. The cloud server 3000 may extract a tag list for each user from a second content management table.

The cloud server 3000 may transmit the extracted tag list of the other users and ID values of the other users to the electronic apparatus 1000, in operation S1315. The electronic apparatus 1000 may display the received ID values of the other users, in operation S1320. For example, the electronic apparatus 1000 may display texts, images, or the like representing the other users. In response to a user input of selecting one from the other users, the electronic apparatus 1000 may display tag list information of the selected user, in operation S1320. The electronic apparatus 10000 may display content items of the other users who are friends of the user of the electronic apparatus 1000 including a specific tagged value, in operation S1325.

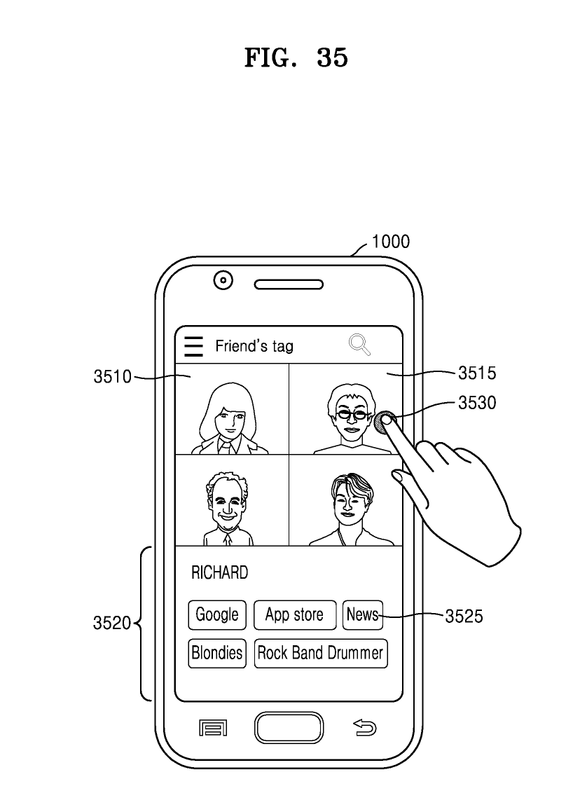

FIG. 35 illustrates an example in which the electronic apparatus 1000 displays a tag list of other users who are friends of a user of the electronic apparatus 1000.

Referring to FIG. 35, the electronic apparatus 1000 may display ID values 3510 of the other users, who are friends of the user of the electronic apparatus 1000. The ID values of the other users, who are friends of the user of the electronic apparatus 1000, may be received from the cloud server 3000. The electronic apparatus 1000 may receive a user input 3530 of selecting a user 3515 from among the other users. Accordingly, the electronic apparatus 1000 may display a tag list 3520 of the selected user.

The user of the electronic apparatus 1000 may select a tagged value (for example, “News”) 3525 included in the tag list of the selected user, and thus receive content of the selected user including the selected tagged value.

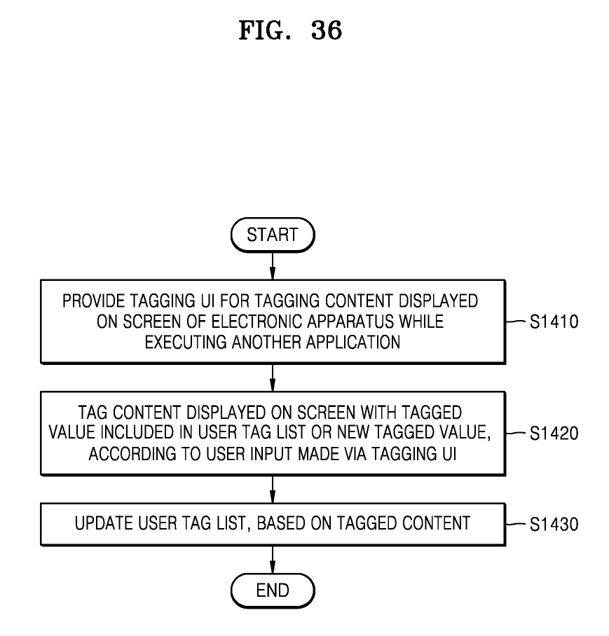

FIG. 36 is a flowchart illustrating an example method in which the electronic apparatus 1000 tags content displayed on another application execution window.

Referring to FIG. 36, in operation S1410, the electronic apparatus 1000 may provide a tagging UI for tagging content displayed on the screen of the electronic apparatus 1000, while executing another application. For example, the electronic apparatus 1000 may display the tagging UI on a portion of the screen on which a browser application is being executed.

In operation S1420, the electronic apparatus 1000 may tag a tagged value included in a user tag list or a new tagged value to the content displayed on the screen, according to a user input made via the tagging UI. For example, the electronic apparatus 1000 may recommend a plurality of candidate tagged values in response to a user input made via the tagging UI. The candidate tagged values may be at least one of the tagged values included in the user tag list and keywords included in the content. In response to a user input of selecting one from the plurality of candidate tagged values, the electronic apparatus 1000 may tag the selected candidate tagged value to the content displayed on the screen.

The electronic apparatus 1000 may receive a user input made via the tagging UI after receiving a user input of selecting an image or text included in the content displayed on the screen. For example, the electronic apparatus 1000 may tag the selected image or text to the content displayed on the screen.

The electronic apparatus 1000 may acquire the content displayed on the screen as the user content. Accordingly, the electronic apparatus 1000 may produce a first content management table.

The electronic apparatus 1000 may transmit information about the acquired user content to the cloud server 3000. For example, the cloud server 3000 may produce a second content management table.

In operation S1430, the electronic apparatus 1000 may update the user tag list, based on the tagged content.

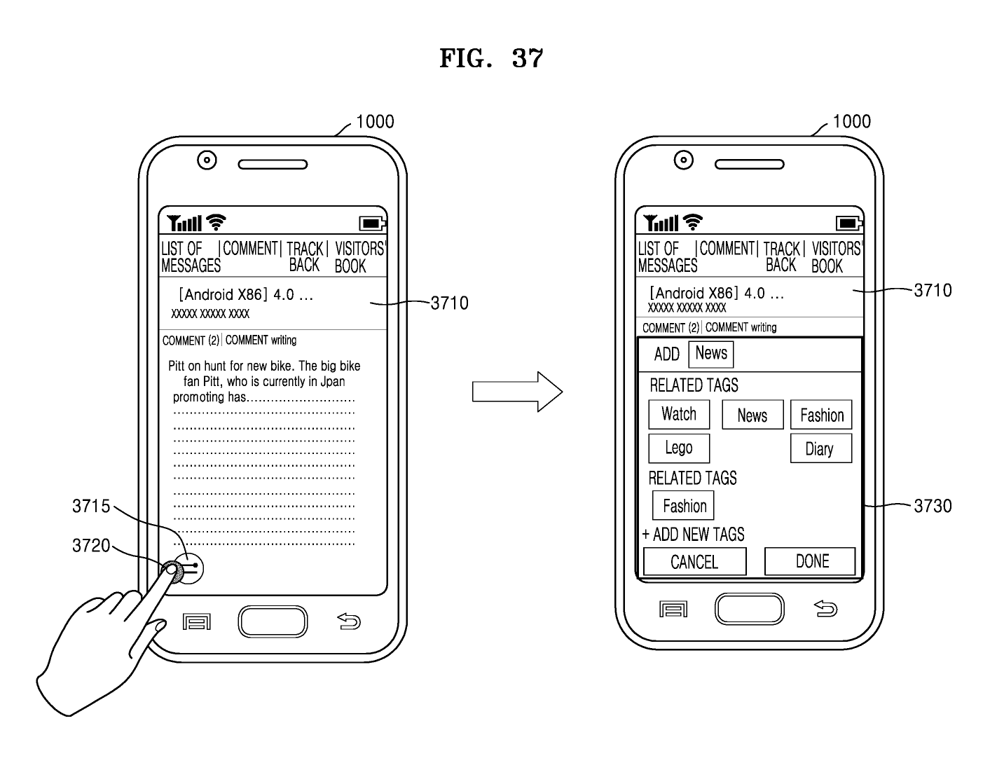

FIG. 37 illustrates an example in which the electronic apparatus 1000 tags content displayed on the screen while executing another application.

Referring to FIG. 37, the electronic apparatus 1000 may provide a tagging UI 3715 for tagging content 3710 displayed on the screen, while executing a web browser application. The electronic apparatus 1000 may receive a user input 3720 via the tagging UI 3715.

The electronic apparatus 1000 may recommend candidate tagged values for tagging the content displayed on the screen. The candidate tagged values may include tagged values (for example, Google, Watch, and News) included in a user tag list. The candidate tagged values may include tagged values recently used by the user. The electronic apparatus 1000 may display a candidate tag list window 3730 including the recommended candidate tagged values. The electronic apparatus 1000 may receive a user input of selecting at least one candidate tagged value, via the candidate tag list window 3730. The electronic apparatus 1000 may tag a selected candidate tagged value to the content 3710 displayed on the screen and acquire the content 3710 displayed on the screen as the user content.

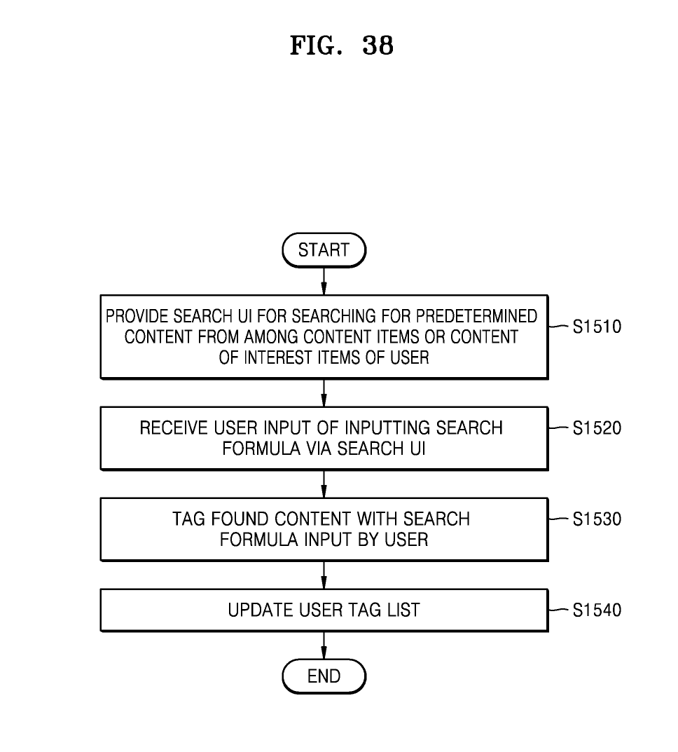

FIG. 38 is a flowchart illustrating an example method in which the electronic apparatus 1000 tags a search formula input via a search UI to found content.

Referring to FIG. 38, in operation S1510, the electronic apparatus 1000 may provide a search UI for searching for predetermined content from among content items or content of interest items of a user. In operation S1520, the electronic apparatus 1000 may receive a user input of inputting a search formula via the search UI. Accordingly, the electronic apparatus 1000 may search for content or content of interest of the user including the search formula.

In operation S1530, the electronic apparatus 1000 may tag the search formula input by the user to found content. Accordingly, the electronic apparatus 1000 may produce or update a first content management table corresponding to each found content. The electronic apparatus 1000 may transmit information about each found content to the cloud server 3000. For example, the cloud server 3000 may produce or update a second content management table corresponding to each found content, based on the information about the found content.

In operation S1540, the electronic apparatus 1000 may update a user tag list. For example, the electronic apparatus 1000 may index the first content management table such that the search formula is included in the user tag list.

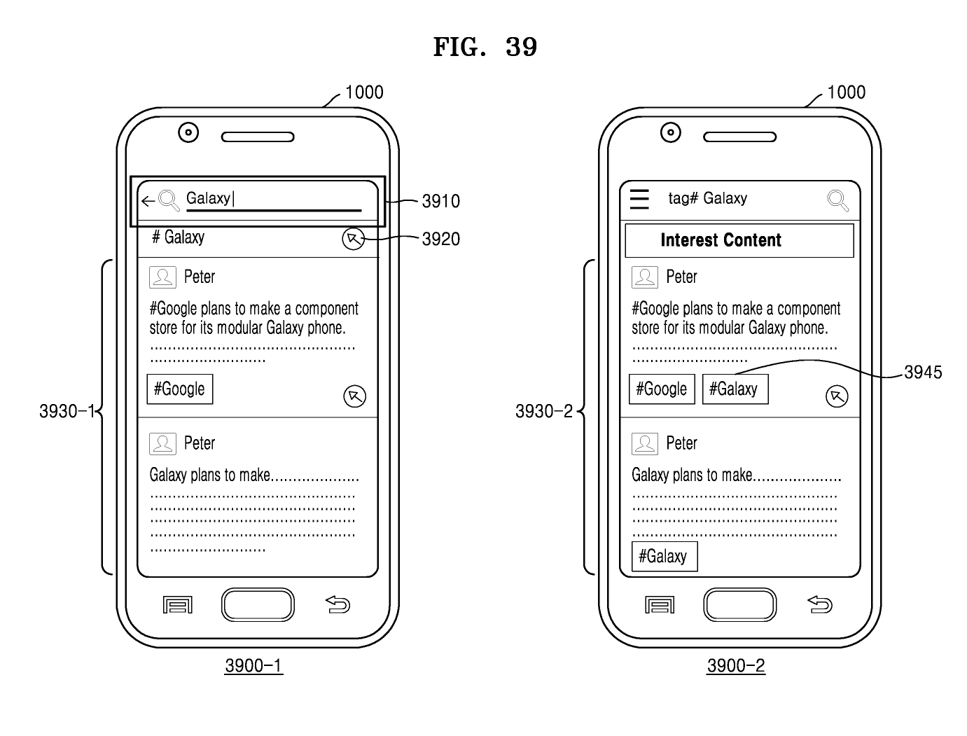

FIG. 39 illustrates an example in which the electronic apparatus 1000 tags a search formula input via a search UI to found content.

Referring to FIG. 39, the electronic apparatus 1000 may provide a search UI 3910 for searching for predetermined content from among content items or content of interest items' of a user. For example, the electronic apparatus 1000 may receive a user input of inputting a search formula “Galaxy” via the search UI 3910. For example, the electronic apparatus 1000 may find content 3930-1 of the user including the search formula “Galaxy”. The electronic apparatus 1000 may display the found content 3930-1 on the screen (3900-1).

The electronic apparatus 1000 may provide a tagging UI 3920 for tagging the search formula “Galaxy” to the found content 3930-1 of the user. In response to a user input made via the tagging UI 3920, the electronic apparatus 1000 may tag a new tagged value “Galaxy” to the found content 3930-1. The electronic apparatus 1000 may display found content 3930-2 including a “#Galaxy” image 3945 corresponding to the new tagged value “Galaxy” (3900-2).

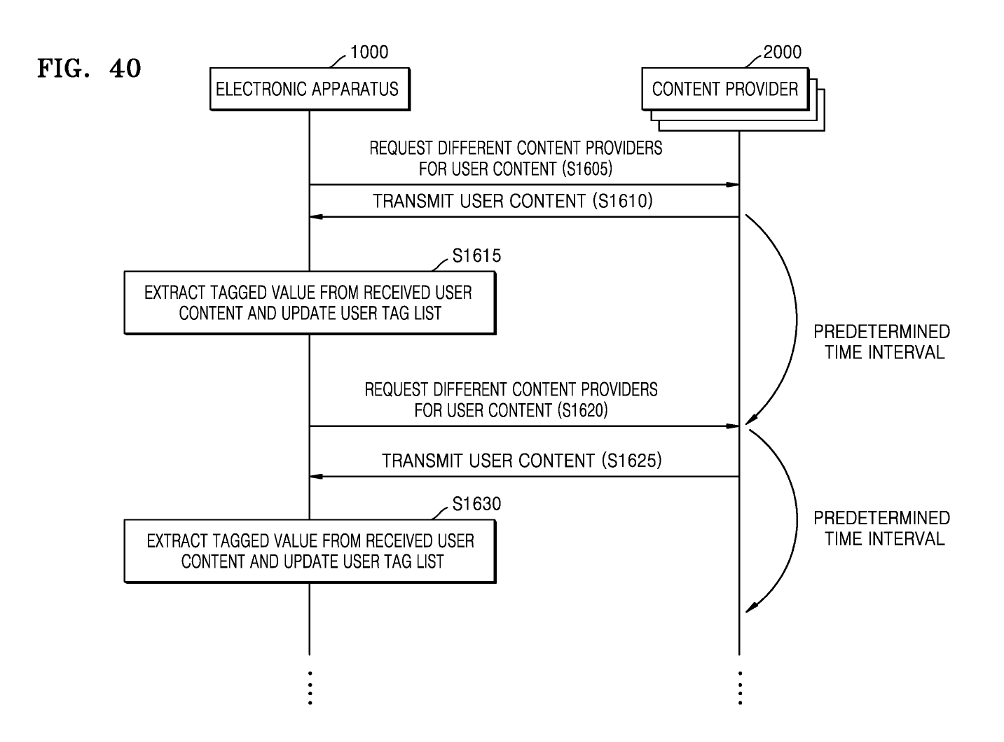

FIG. 40 is a flowchart illustrating an example method in which the electronic apparatus 1000 acquires content of a user from a content provider at regular intervals.

Referring to FIG. 40, the electronic apparatus 1000 may set content of a user to be received at regular intervals. For example, the electronic apparatus 1000 may set a back-up mode for the user content. For example, the electronic apparatus 1000 may request different content providers 2000 for the user content at a predetermined time point, in operation S1605. Accordingly, the different content providers 2000 may transmit the user content to the electronic apparatus 1000, in operation S1610. The electronic apparatus 1000 may extract a tagged value from the received user content and update a user tag list, in operation S1615.

After a predetermined time interval, the electronic apparatus 1000 may request the different content providers 2000 for the user content again, in operation S1620. The different content providers 2000 may transmit the user content to the electronic apparatus 1000, in operation S1625. The electronic apparatus 1000 may extract a tagged value from the received user content and update the user tag list, in operation S1630.

The electronic apparatus 1000 may determine the time interval (hereinafter, referred to as a backup time interval) when the content providers 2000 are requested to provide the user content, based on an input by the user or a terminal status of the user.

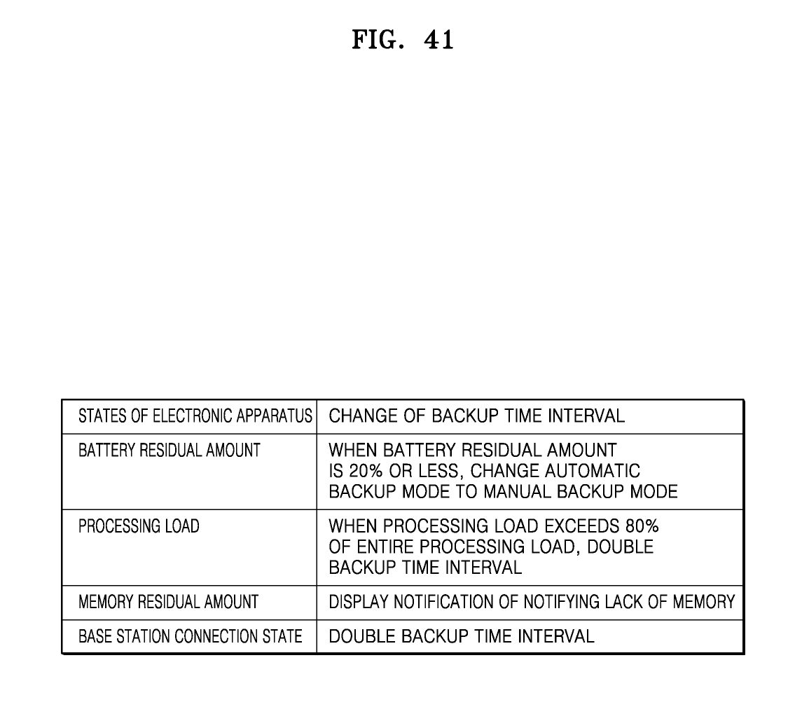

FIG. 41 a diagram illustrating an example in which the electronic apparatus 1000 diversifies the backup time interval according to states of the electronic apparatus 1000.

Referring to FIG. 41, even when a user input or preset value of determining the backup time interval exists, the electronic apparatus 1000 may diversify the backup time interval according to the states of the electronic apparatus 1000. The states of the electronic apparatus 1000 may include at least one of a residual battery amount of the electronic apparatus 1000, a processing amount, a residual memory amount, and a base station connection state.

For example, when the residual battery amount of the electronic apparatus 1000 is 20% or less, the electronic apparatus 1000 may change an automatic backup mode to a manual backup mode. The manual backup mode may be a mode in which the electronic apparatus 1000 requests the content provider 2000 for content of a user only when a user input is received. When a processing load of the electronic apparatus 1000 exceeds 80% of the entire processing load, the electronic apparatus 1000 may double the backup time interval. When the residual memory amount of the electronic apparatus 1000 is 30% or less, the electronic apparatus 1000 may display a notification of notifying a lack of memory. The electronic apparatus 1000 may double the backup time interval based on connection states of the electronic apparatus 1000 with a base station, but examples are not limited thereto.

As such, the electronic apparatus 1000 may disperse the time required to acquire many user content items at a time and the processing load of the electronic apparatus 1000 for extracting a tagged value included in the content of each user, by acquiring the user content at regular intervals. In addition, the electronic apparatus 1000 may manage the acquired user content such that the acquired user content is not lost, by storing the acquired user content in at least one of the electronic apparatus 1000 and the cloud server 3000.

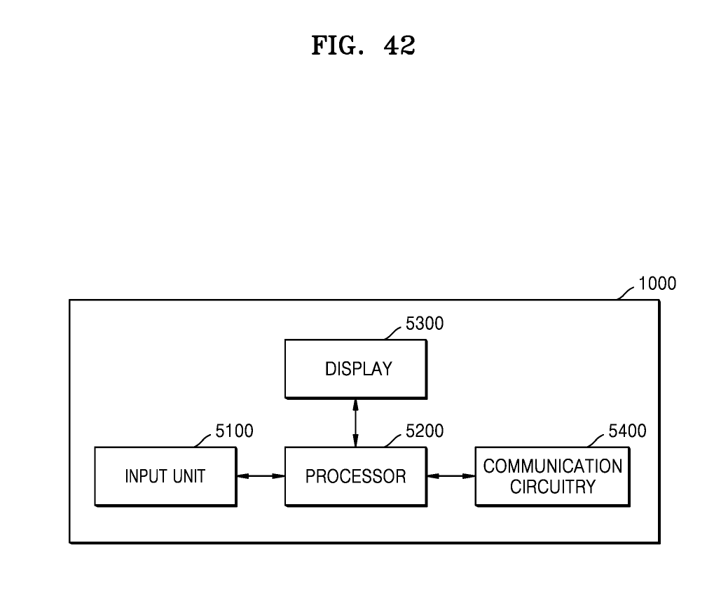

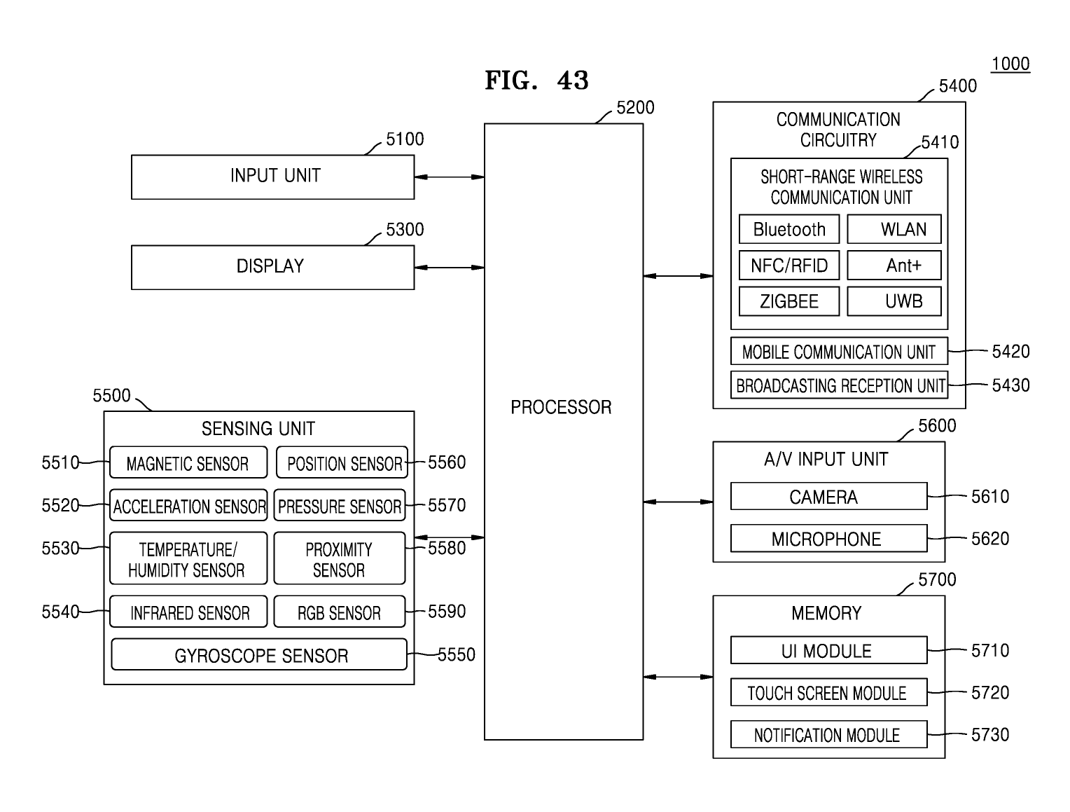

FIGS. 42 and 43 are block diagrams illustrating an example electronic apparatus 1000.

Referring to FIG. 42, the electronic apparatus 1000 may include an input unit 5100, a processor 5200, a display 5300, and communication circuitry 5400. However, all of the illustrated components are not essential.

The electronic apparatus 1000 may be implemented by more components than those illustrated in each of FIGS. 42 and 43 or by fewer components than those illustrated in each of FIGS. 42 and 43.

For example, referring to FIG. 43, the electronic apparatus 1000 may include a sensing unit comprising plural sensors 5500, an audio/video (A/V) input unit 5600, and a memory 5700, in addition to the input unit 5100, the processor 5200, the display 5300, and the communication circuitry 5400 of FIG. 42.

The aforementioned components will now be described in greater detail.

The input unit 5100 denotes a unit via which a user inputs data for controlling the electronic apparatus 1000. For example, the input unit 5100 may be, but is not limited to, a key pad, a dome switch, a touch pad (e.g., a capacitive overlay type, a resistive overlay type, an infrared beam type, an integral strain gauge type, a surface acoustic wave type, a piezo electric type, or the like), a jog wheel, or a jog switch, etc.

The input unit 5100 may receive a user input of selecting a content provider 2000. The input unit 5100 may receive a user input of selecting one tag value from a user tag list.

The input unit 5100 may receive a user input of selecting a text or image from content or content of interest of a user. The input unit 5100 may receive a user input of selecting one candidate tagged value from among candidate tagged values recommended by the electronic apparatus 1000.

The input unit 5100 may also receive user inputs with respect to various UIs provided by the electronic apparatus 1000.

The processor 5200 may typically be configured to control overall operations of the electronic apparatus 1000. For example, the processor 5200 may be configured to control the input unit 5100, the display 5200, the communication circuitry 5400, and the A/V input unit 5600 by, for example, executing programs stored in the memory 5700.

The processor 5200 may be configured to extract a tagged value included in user content that is provided by the content provider 2000. The processor 5200 may be configured to tag a new tagged value to the user content. The processor 5200 may be configured to automatically generate a tagged value and may tag the generated tagged value to the user content. For example, the processor 5200 may be configured to automatically tag content or content of interest of a user with a keyword that is the same as or similar to a tagged value included in a user tag list from among keywords included in the content or content of interest of the user.

The processor 5200 may be configured to produce a user tag list including the extracted tagged value. The processor 5200 may be configured to produce a content management table for each user content item. The processor 5200 may be configured to index the content management table with the tagged value. The processor 5200 may be configured to control the display 5300 to display a user tag list including tagged values mapped with the address of the indexed content management table. The processor 5200 may be configured to update the user tag list as a tagged value included in the user tag list or a new tagged value is tagged to the content or content of interest of the user.

The processor 5200 may be configured to produce a user tag list including an upper tag value and a lower tagged value.

The processor 5200 may be configured to search for content of interest of the user by using a tagged value included in the user tag list. According to some examples, as described above, the content of interest may be content found from the user content. The content of interest may be content found from the content items included in the RSS feed to which the user subscribes. The content of interest may be content found from content items that are provided by a news content provider. The content of interest may be content found from content items of other users who are friends of the user of the electronic apparatus 1000. For example, the electronic apparatus 1000 may acquire information about the other users and content of the other users from the cloud server 3000 via the communication circuitry 5400 of the electronic apparatus 1000.

The processor 5200 may be configured to set weights corresponding to content usage behaviors of each user. The processor 5200 may be configured to change the weights corresponding to the content usage behaviors of each user according to settings of the electronic apparatus 1000. For example, the processor 5200 may be configured to set a high weight to a most-frequent content usage behavior by analyzing the weights for the content usage behaviors of the user.

The processor 5200 may be configured to classify user content items, based on content usage behaviors of the user.

The processor 5200 may be configured to determine a plurality of candidate tagged values, based on at least one of tagged values included in a user tag list and keywords included in the content. The processor 5200 may be configured to recommend the determined candidate tagged values. The processor 5200 may be configured to tag one candidate tagged value from among the plurality of candidate tagged values to the user content or the content of interest of the user, based on a value provided by the user input unit 5100.

The processor 5200 may be configured to provide various UIs, and perform various operations based on user inputs made via the various UIs. For example, the processor 5200 may be configured to tag the content or content of interest of the user with the tagged value included in the user tag list or the new tagged value, based on a user input made via the tagging UI.

The display 5300 may display information that is processed by the electronic apparatus 1000. For example, the display 5300 may display the content or content of interest of the user. The display 5300 may display the user content items classified based on the content usage behaviors of the user. The display 5300 may display a user tag list including tagged values by indexing the user content items with the tagged values.

The display 5300 may display a content provider list including an ID value of the content provider 2000. The display 5300 may display a tag list of the other users. For example, the display 5300 may display the tag list of the other users who are the friends of the user of the electronic apparatus 1000.

The display 5300 may display various UIs. For example, the display 5300 may display a tagging UI for tagging a new tagged value or a tagged value included in the user tag list to the user content or the content of interest of the user, a search UI for searching for the user content or the content of interest of the user, and a tagging UI for tagging content displayed on the screen while another application is being executed.

When the display 5300 forms a layer structure together with a touch pad to construct a touch screen, the display 5300 may be used as an input device as well as an output device. The display 5300 may include, for example, at least one of a liquid crystal display (LCD), a thin film transistor-liquid crystal display (TFT-LCD), an organic light-emitting diode (OLED), a flexible display, a 3D display, and an electrophoretic display. According to examples of the electronic apparatus 1000, the electronic apparatus 1000 may include at least two displays 5300. The at least two displays 5300 may be disposed to face each other by using a hinge.

The communication circuitry 5400 may include at least one component that enables communication between the electronic apparatus 1000 and a plurality of content providers 200, between the electronic apparatus 1000 and the cloud server 3000 or between the electronic apparatus 1000 and an external apparatus. For example, the communication circuitry 5400 may include a short-range wireless communication unit 5410, a mobile communication unit 5420, and a broadcasting reception unit 5430.

The short-range wireless communication unit 5410 may include, but is not limited to, a Bluetooth communication circuitry, a Bluetooth Low Energy (BLE) communication circuitry, a near field communication (NFC) unit, a wireless local area network (WLAN) (e.g., Wi-Fi) communication circuitry, a ZigBee communication circuitry, an infrared Data Association (IrDA) communication circuitry, a Wi-Fi direct (WFD) communication circuitry, an ultra wideband (UWB) communication circuitry, an Ant+ communication circuitry, and the like.

The mobile communication unit 5420 may exchange a wireless signal with at least one selected from a base station, an external terminal, and a server on a mobile communication network. Examples of the wireless signal may include a voice call signal, a video call signal, and various types of data generated during a short message service (SMS)/multimedia messaging service (MMS).

The broadcasting reception unit 5430 receives a broadcasting signal and/or broadcasting-related information from an external source via a broadcasting channel. The broadcasting channel may be a satellite channel, a ground wave channel, or the like. According to examples, the electronic apparatus 1000 may not include the broadcasting reception unit 5430.

According to some examples, the electronic apparatus 5400 may acquire content of a user from different content providers 2000. The communication circuitry 5400 may acquire content of a user in which preference of the user has been reflected, from the different content providers 2000. For example, the communication circuitry 5400 may acquire preferred user content, based on respective weights for content usage behaviors of the user. The communication circuitry 5400 may transmit information about the tagging to the content providers 2000.

The communication circuitry 5400 may transmit an ID value of the user of the electronic apparatus 1000 and the information about the user content to the cloud server 3000. The communication circuitry 5400 may acquire the user tag list from the cloud server 3000. The communication circuitry 5400 may also acquire the content or content of interest of the user.

The communication circuitry 5400 may acquire from the cloud server 3000 at least one content items of the other users, who are friends of the user of the electronic apparatus 1000, and ID values of the other users. The communication circuitry 5400 may acquire content items of the other users including the same tagged value as a tagged value included in the user tag list.

The sensing unit 5500 may include, but is not limited thereto, at least one sensor selected from a magnetic sensor 5510, an acceleration sensor 5520, a temperature/humidity sensor 5530, an infrared sensor 5540, a gyroscope sensor 5550, a position sensor 5560, a pressure sensor 5570, a proximity sensor 5580, and an RGB sensor 5590 (i.e., an illumination sensor). Functions of most of the sensors would be understood by one of ordinary skill in the art in view of their names and thus detailed descriptions thereof will be omitted herein.

The A/V input unit 5600 may be configured to input an audio signal or a video signal, and may include, for example, a camera 5610 and a microphone 5620. The camera 5610 may acquire an image frame, such as a still image or a moving picture, via an image sensor in a video call mode or a photography mode. An image captured via the image sensor may be processed by the processor 5200 or a separate image processor (not shown).

The image frame obtained by the camera 5610 may be stored in the memory 5700 or transmitted to the outside via the communication circuitry 5400. At least two cameras 5610 may be included according to examples of the structure of a terminal.

The microphone 5620 may receive an external audio signal and converts the external audio signal into electrical audio data. For example, the microphone 5620 may receive an audio signal from an external device or a speaking person. The microphone 5620 may use various noise removal algorithms in order to remove noise that is generated while receiving the external audio signal.

The memory 5700 may store a program used by the processor 5200 to perform processing and control, and may also store input/output data (for example, a plurality of menus, a plurality of first hierarchical sub-menus respectively corresponding to the plurality of menus, and a plurality of second hierarchical sub-menus respectively corresponding to the plurality of first hierarchical sub-menus).

The memory 5700 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. The electronic apparatus 1000 may operate a web storage or a cloud server on the internet which performs a storage function of the memory 5700.

The programs stored in the memory 5700 may be classified into a plurality of modules based on their functions, for example, a UI module 5710, a touch screen module 5720, and a notification module 5730.

The UI module 5710 may provide a UI, GUI, or the like that may be specialized for each application and interoperates with the electronic apparatus 1000. The touch screen module 5720 may detect a touch gesture on a touch screen of a user and transmit information regarding the touch gesture to the processor 5200. The touch screen module 5720 according to an example of the disclosure may recognize and analyze a touch code. The touch screen module 5720 may be configured by separate hardware including a controller.

In order to detect the actual touch or the proximate touch on the touch pad, the touch screen may internally or externally include various sensors. An example of a sensor used to detect the real touch or the proximity touch on the touch screen is a tactile sensor. The tactile sensor denotes a sensor that detects a touch by a specific object to a degree to which a human feels or more. The tactile sensor may detect various types of information, such as the roughness of a touched surface, the hardness of the touching object, the temperature of a touched point, and the like.

Another example of a sensor used to detect the real touch or the proximity touch on the touch screen is a proximity sensor.

The proximity sensor may be a sensor that detects the existence of an object that approaches a predetermined detection surface or that exists nearby, by using an electromagnetic force or infrared rays, without using any mechanical contact. Examples of the proximity sensor include a transmission-type photoelectric sensor, a direct reflection-type photoelectric sensor, a mirror reflection-type photoelectric sensor, a high frequency oscillation-type proximity sensor, a capacity-type proximity sensor, a magnetic proximity sensor, an infrared-type proximity sensor, or the like. Examples of the touch gesture of the user may include tap, touch and hold, double tap, drag, flick, swipe, and the like.

The notification module 5730 may generate a notification signal, for example, in order to notify that an event has been generated in the electronic apparatus 1000. Examples of the event generated in the electronic apparatus 1000 may include, for example, call signal receiving, message receiving, a key signal input, schedule notification, and the like. The notification module 5730 may output a notification signal in the form of a video signal via the display 5300, in the form of an audio signal via a speaker or the like, or in the form of a vibration signal.

A method according to an example of the disclosure may be embodied as program commands executable by various processing circuitry and may be recorded on a computer-readable recording medium. The computer-readable recording medium may include program commands, data files, data structures, and the like separately or in combinations. The program commands to be recorded on the computer-readable recording medium may be specially designed and configured for examples of the disclosure or may be well-known to and be usable by one of ordinary skill in the art of computer software. Examples of the computer-readable recording medium include a magnetic medium such as a hard disk, a floppy disk, or a magnetic tape, an optical medium such as a compact disk-read-only memory (CD-ROM) or a digital versatile disk (DVD), a magneto-optical medium such as a floptical disk, and a hardware device specially configured to store and execute program commands such as a ROM, a random-access memory (RAM), or a flash memory. Examples of the program commands are advanced language codes that can be executed by a processor using an interpreter or the like as well as machine language codes made by a compiler.

The above-described example embodiments of the disclosure and all of the above-described functional operations may be implemented within a digital electronic circuit, within computer software, firmware, or hardware including the above-disclosed structures and their equivalent structures, or within a combination including at least one thereof.

The example embodiments should be considered in descriptive sense only and not for purposes of limitation. Descriptions of features or aspects within each example should typically be considered as available for other similar features or aspects in other examples.

While the disclosure has been illustrated and described with reference to example embodiments thereof, it will be understood by those of ordinary skill in the art that various changes in form and details may be made therein without departing from the spirit and scope of the disclosure as defined by the following claims.

What is claimed is:

1. A content providing method comprising:
acquiring at least one content item from a content provider;
extracting at least one tagged value from each of the at least one content item;
producing a tag list, based on the extracted at least one tagged value; and
searching for content of interest using the at least one tagged value included in the tag list.

2. The method of claim 1, wherein the extracted at least one tagged value is listed within the tag list, and the tag list is produced by indexing the content including the extracted tagged value with the extracted tagged value.

3. The method of claim 1, wherein the at least one content is acquired based on respective weights of content usage behaviors.

4. The method of claim 3, further comprising:
classifying the at least one content, based on the content usage behaviors; and
displaying the classified at least one content.

5. The method of claim 1, further comprising:
tagging the content with a tagged value generated based on a received input;
updating the tag list, based on the tagged content; and
transmitting information about the tagging to the content provider.

6. The method of claim 5, wherein the tagging of the content comprises:
recommending a plurality of candidate tagged values, based on at least one of the at least one tagged value included in the tag list and keywords included in the content; and
in response to selecting at least one from the plurality of candidate tagged values, tagging the content with the selected candidate tagged value.

7. The method of claim 1, further comprising:
tagging the content with a keyword the same as the at least one tagged value included in the tag list from among keywords included in the content;
updating the tag list, as the content is tagged with the keyword; and
transmitting information about the tagging to the content provider.

8. The method of claim 1, wherein the tag list is produced in a hierarchical structure including an upper tagged value and a lower tagged value.

9. The method of claim 1, wherein the content of interest is found from the at least one content.

10. The method of claim 1, wherein the content of interest is found from content items included in a really simple syndication (RSS) feed.

11. The content providing method of claim 1, wherein
the content of interest is found from content items of others, and
the searching for the content of interest comprises acquiring the content items of the others including a tag value that is the same as the at least one tagged value included in the tag list.

12. An electronic apparatus comprising:
communication circuitry configured to acquire at least one content item from a content provider;
a processor configured to extract at least one tagged value from each of the at least one content item, to produce a tag list based on the extracted at least one tagged value, and to search for content of interest using the at least one tagged value included in the tag list; and
a display configured to display the content of interest.

13. The electronic apparatus of claim 12, wherein
the processor is configured to index the content including the extracted at least one tagged value with the extracted at least one tagged value, and
the tag list is produced by indexing the content including the extracted at least one tagged value with the extracted at least one tagged value.

14. The electronic apparatus of claim 12, wherein the at least one content is acquired based on respective weights of content usage behaviors.

15. The electronic apparatus of claim 14, wherein
the processor is configured to classify the at least one content, based on the content usage behaviors, and
the display displays the classified at least one content.

16. The electronic apparatus of claim 12, wherein
the processor is configured to tag the content with a tagged value generated based on a received input, and to update the tag list based on the tagged content, and
the communication circuitry is configured to transmit information about the tagging to the content provider.

17. The electronic apparatus of claim 16, wherein the processor is configured to recommend a plurality of candidate tagged values, based on at least one of the at least one tagged value included in the tag list and keywords included in the content, and, in response to a selection of at least one from the plurality of candidate tagged values, to tag the content with the selected candidate tagged value.

18. The electronic apparatus of claim 17, wherein
the processor is configured to tag the content with a keyword that is the same as the at least one tagged value included in the tag list from among keywords included in the content, and to update the tag list as the content is tagged with the keyword, and
the communication circuitry is configured to transmit information about the tagging to the content provider.

19. The electronic apparatus of claim 12, wherein the content of interest is found from the at least one content.

20. The electronic apparatus of claim 12, wherein the content of interest is found from content items included in a really simple syndication (RSS) feed.

21. The electronic apparatus of claim 12, wherein
the content of interest is found from content items of others, and
the communication circuitry is configured to acquire the content items of the others including a tag value that is the same as the at least one tagged value included in the tag list.

22. A non-transitory computer-readable recording medium having recorded thereon a computer program, which, when executed by a computer, performs the method of claim 1.
